(19) United States
(12) Patent Application Publication
(10) Pub. No.: US 2016/0332902 A1
(43) Pub. Date: Nov. 17, 2016

(54) METHODS FOR REMOVING CONTAMINANTS FROM AQUEOUS SOLUTIONS USING PHOTOELECTROCATALYTIC OXIDIZATION

(71) Applicant: Wisconsin Alumni Research Foundation, Madison, WI (US)

(72) Inventors: Terence P. Barry, Middleton, WI (US); Dean T. Tompkins, Madison, WI (US); Marc A. Anderson, Madison, WI (US); Walter A. Zeltner, Oregon, WI (US)

(21) Appl. No.: 15/219,889

(22) Filed: Jul. 26, 2016

Related U.S. Application Data
(63) Continuation of application No. 12/977,347, filed on Dec. 23, 2010, now abandoned.
Application No. 12/977,347 is a continuation-in-part of application No. 12/369,219, filed on Feb. 11, 2009.
(60) Provisional application No. 61/027,622, filed on Feb. 11, 2008.

(51) Int. Cl. C02F 9/00; C02F 1/28; C02F 1/72; C02F 1/467; C02F 1/32; C25B 11/03; A01K 63/04; A01K 61/00

(52) U.S. Cl. CPC C02F 9/00; A01K 63/042; C02F 1/283; A01K 61/005; C02F 1/4672; A01K 61/00; C02F 1/325; C25B 11/035; C02F 1/725; C02F 2103/06

(57) ABSTRACT

A photoelectrocatalytic oxidizing device having a photoanode being constructed from a conducting metal such as Ti as the support electrode. Alternatively, the photoanode is a composite electrode comprising a conducting metal such as Ti as the support electrode coated with a thin film of sintered nanoporous TiO₂. The device is useful in methods for treating an aqueous solution such as groundwater, wastewater, drinking water, ballast water, aquarium water, and aquaculture water to reduce amounts of a contaminant. The method being directed at reducing the amount and concentration of contaminants in an aqueous solution comprising providing an aqueous solution comprising at least one contaminant, and, photoelectrocatalytically oxidizing the contaminant, wherein the contaminant is oxidized by a free radical produced by a photoanode constructed from an anatase polymorph of Ti, a rutile polymorph of Ti, or a nanoporous film of TiO₂.

### CROSS REFERENCE TO RELATED APPLICATIONS

This application claims priority to and benefit of U.S. patent application Ser. No. 12/977,347 filed Dec. 23, 2010, which claims priority to and benefit of U.S. patent application Ser. No. 12/369,219 filed Feb. 11, 2009, which claims priority to and benefit of U.S. Provisional Patent Application Ser. No. 61/027,622 filed Feb. 11, 2008, which is hereby incorporated herein by reference in its entirety.

This application is related to commonly-owned U.S. patent application Ser. No. 11/932,741, which is hereby incorporated by reference.

This application is related to commonly-owned U.S. patent application Ser. No. 11/932,519, which is hereby incorporated by reference.

### STATEMENT REGARDING GOVERNMENT INTEREST

This invention was made with government support under 2007-33610-18003 awarded by the USDA/CSREES. The United States Government has certain rights in the invention.

### BACKGROUND OF THE DISCLOSURE

The present disclosure generally relates to the removal of contaminants from aqueous solutions. Particularly, methods are disclosed for the removal of organismal and chemical contaminants from aqueous solutions including groundwater, wastewater, drinking water, aquaculture (e.g., aquarium water and aquawater) and ballast water.

Water recirculation systems are expected to play a key role in the expansion of aquaculture production in the United States because they provide year-round production of aquatic organisms under controlled conditions. Closed recirculation systems require little water and land, have minimal effluent discharge, and, can be constructed and operated almost anywhere including within cities close to major markets. Closed hatchery systems can also be operated in a biosecure manner unlike other forms of aquaculture.

Fish sensitivity to ammonia and nitrite toxicity is a major factor limiting expansion of an environmentally sustainable aquaculture industry reliant on water recirculation technology. Closed recirculating aquaculture systems provide year-round fish production under controlled conditions. Pond, net-pen and flow-through culture systems require significantly more water and land. In contrast, very little water and land are needed for closed, recirculating aquaculture systems, which also yield minimal effluent discharge.

Closed, recirculating aquaculture systems may also be advantageously constructed and operated in cities proximate to major markets. At present, however, it is more cost effective to produce food fish in ponds and other open systems due to the high cost of building and operating complex biofiltration units, which are currently required for effective recirculation systems.

Currently, however, recirculation aquaculture is generally unfavorable economically primarily because of the high costs of constructing and operating the complex systems required for water circulation, solids capture, oxygenation, and nitrogenous waste removal. Nitrogenous waste removal is particularly problematic. Numerous technological approaches have been attempted to remove ammonia from recirculated water including trickle filters, rotating drums, and floating bead filters.

Disadvantages of biofilters include a high concentration of nitrates, a compromise between fish and bacteria for optimal growing conditions (e.g., temperature), and bacterial growth that clogs filter pores and reduces filtration efficiency. Cleaning of biofilters can also reduce bacterial populations. New biofilters take 4-6 weeks to become operational, and, for this reason, biofilters cannot be used intermittently. Still other disadvantages include disturbances such as adding more fish or overfeeding fish that lead to spikes in ammonia, and difficulty in treating sick fish with antibiotics which may also kill beneficial nitrifying bacteria populations on the biofilters.

Aquaria and recirculation aquaculture systems generally have few or no anoxic zones. Therefore, nitrates must be removed by periodic water exchanges. Optimization is difficult because aquaculture biofiltration systems require good growing conditions for both the fish and bacteria. However, optimal temperatures for fish growth may be suboptimal for nitrifying bacteria. Existing biofiltration systems used in aquaria and other aquaculture systems have numerous other limitations. For example, autotrophic nitrifying bacteria and competing heterotrophic bacteria colonize within biofilters clogging filter pores and reducing nitrification efficiency.

In general, sufficient nitrifying bacteria populations require around 6 weeks to establish in new biofilters. Therefore, current systems cannot filter intermittently. The filters must be operated even if there are temporarily no fish in the system to maintain biofilter activity. Even minor disturbances (such as tank cleaning, overfeeding, or adding new fish) can disrupt delicate nitrifying bacteria population equilibrium leading to ammonia spikes. Sick fish cannot be treated with antibiotics because antibiotics kill nitrifying bacteria.

Such limitations associated with biofiltration systems curtail the production of aquatic organisms in water reuse systems. Autotrophic nitrifying bacteria and heterotrophic bacteria can colonize the biofilters, which clog filter pores and reduce the efficiency of nitrification. Biofilters are difficult to clean without reducing the beneficial bacterial populations. Nitrifying bacteria grow slowly taking weeks for sufficient populations of nitrifying bacteria to become established in new biofilters. Even minor disturbances, such as tank cleaning, overfeeding, or adding new fish, can disrupt the delicate equilibrium of the nitrifying bacteria populations leading to spikes in ammonia. Nitrates accumulate in the water, which stimulates the production of nuisance algae. Nitrates can only be removed from the closed system by periodic water exchange. Such problems increase maintenance time and costs in all systems as well as salt disposal problems associated with seawater systems.

Nitrogenous waste removal in open systems is particularly problematic. Numerous approaches have been investigated, including trickle filters, rotating drums, and floating bead filters. (Abeysinghe D et al., 1996, Biofilters for water reuse in aquaculture, Water Sci. Technol. 34:253-260; deLosReyes A et al., 1996, Combination of a bead filter and rotating biological contactor in a recirculating fish culture system, Aquacul. Eng. 15:27-39; Van Rijn J, 1996, The potential for integrated biological treatment systems in recirculating fish culture-A review, Aquacul. 139:181-201; and, Malone R et al., 2000, Use of floating bead filters to recondition recirculating waters in warm water aquaculture production systems, Aquacul. Eng. 22:57-73).

Other methods for eliminating nitrogenous wastes utilize biological processes based on bacterial nitrification and de-nitrification. (Cooper P et al., 1994, Process options for phosphorus and nitrogen removal from wastewater, J. Inst. Water Environ. Manag. 8:84-92). Ammonia converts to nitrate using two types of aerobic autotrophic bacteria. One bacteria oxidizes ammonia to nitrite (NO₂), and the other converts nitrite to nitrate (NO₃⁻).

Under anoxic conditions, heterotrophic denitrifying bacteria reduce nitrite and nitrate to nitrogen gas. Autotrophic ammonia-oxidizing bacteria are generally characterized by low growth rates and yields. In general, nitrification is the rate-limiting step in biological nitrogen removal processes. Maintaining adequate levels of nitrifiers is a significant problem in biological removal processes.

Nitrifiers and de-nitrifiers require different environmental conditions for growth. In wastewater treatment plants, total nitrogen removal is commonly achieved using a two-stage system. Both steps can, however, occur simultaneously in a single reactor. (Helmer C et al., 1998, Simultaneous nitrification/denitrification in an aerobic system, Water Sci. Technol. 37:183-187).

Zebrafish rearing systems are used extensively in biomedical research. Bacterial metabolites associated with and produced by biofilters can adversely affect physiological responses of certified disease-free fish strains. Thus, there is an absence or shortage of certified disease-free zebrafish.

Electrochemical oxidation has been an alternative approach to solving the ammonia removal problem. (Chen D, 2004, Electrochemical technologies in wastewater treatment, Sep. Purif Technol. 38:11-41). Electrochemical oxidation (as opposed to photoelectrochemical oxidation) is an alternative approach to solving the ammonia removal problem. Such methods, which utilize electrodes and electrical potentials to oxidize nitrogenous compounds, are attractive because they can overcome many of the drawbacks of biological techniques. Electrochemical methods produce little or no sludge, can work with high or variable pollutant concentrations, and are generally unaffected by the presence of impurities.

Electrochemical oxidation systems and processes employ electrodes and electrical potential to oxidize nitrogenous compounds. In principle, oxidation can be controlled by applying particular voltages. In the general sequence of increasing voltages, ammonium is oxidized to higher oxidation states in the order of ammonium (NH₄⁺), nitrogen gas (N₂), nitrite (NO₂) and nitrate (NO₃⁻). Ideally, one would like to oxidize ammonium to nitrogen gas which would then exit the system. However this has not normally been possible using electrochemical systems. Electrochemical oxidation systems produce little or no sludge. Electrochemical oxidation systems also treat high and/or variable pollutant concentrations. Such systems are also substantially unaffected by the presence of impurities. Use of an electrochemical oxidation process to remove 100% of ammonia (2600 mg/L) in a landfall leachate has been reported. (Chiang L et al., 1995, Indirect oxidation effects in electrochemical oxidation treatment of landfill leachate, Water Res. 29:671-678).

During electrochemical oxidation, the concentration ratio HClO:N₂ and pH influence the production rate of chloramines such as NH₂Cl, NHCl₂ and NCl₃. The efficiency of ammonia oxidation through in situ production of hypochlorite has been reported. (Lin S H et al., 1996, Electrochemical removal of nitrite and ammonia for aquaculture, Water Res. 30, 715-721; Lin S et al., 1997, Electrochemical nitrite and ammonia oxidation in seawater, J. Environ. Sci. Health, Part A A32:2125-2138).

However, several oxygen-containing anions are generated during electrochemical oxidation, such as SO₄²⁻, ClO₃⁻ and ClO₄, and these specie inhibit the formation of ClO⁻ ions, which slows the destruction/oxidation of ammonia. (Czarnetzki L et al., 1992, Formation of hypochlorite, chlorate and oxygen during NaCl electrolysis from alkaline-solutions at a RuO₂/TiO₂ anode, J. Appl. Electrochem. 22:315-324; and, Chiang H et al., 1996, Photodegradation of chlorinated organic wastes with N—TiO₂ promoted by P—CuO, J. Chinese Chem. Soc. 43:21-27). When ammonia is chlorinated, final products may include toxic chlorine gas and explosive nitrogen trichloride. Moreover, the electrochemical method may require high levels of energy, and chloride ions must be added to the system for the method to work. The electrodes may also require titanium-based boron-doped diamond film electrodes (Ti/BDD) that demonstrate high activity and reasonable stability. However, such electrodes are very expensive. Other alternatives to biological filtration, such as ammonia stripping and ion exchange, are impractical or uneconomical in most circumstances.

In addition to nitrogenous wastes, various other contaminants have been found in aquacultures and other aqueous solutions such as groundwater. Groundwater pollution or contamination may be caused by human activities such as application of fertilizers, herbicides, and pesticides to crops, and/or originate from industrial waste disposal, accidental spills, leaking fuel storage tanks, dumps and landfills. Large-scale use and leaking of underground fuel storage tanks, for example, has resulted in groundwater contamination by gasoline and fuels. Additionally, groundwater contamination may occur naturally such as, for example, by arsenic.

Organisms may also contaminate water and aqueous environments and is one of the world's largest health concerns. Organisms such as, for example, insects, nematodes, bacteria, protists (protozoa), and viruses may contaminate water. Moreover, many of these organisms produce cysts that may exist in water. For example, Giardia can form cysts that survive from weeks to months in water from wells, water systems, and stagnant water sources. These cysts may be resistant to conventional water treatment methods.

Organisms and other wastes may also contaminate ballast water used in ships for stability and trim. Once the ship arrives at its destination it may release the ballast water into the new water. Subsequent release of the ballast water can result in the introduction of exotic and non-native species and may cause detrimental impact on the environment and local economy.

Various methods exist for removing contamination from aqueous solutions. Generally, for example, contaminants may be contained to prevent them from migrating from their source, removed, and immobilized or detoxified.

Another method is to treat the aqueous solution at its point-of-use. Point-of-use water treatment refers to a variety of different water treatment methods (physical, chemical and biological) for improving water quality for an intended use such as, for example, drinking, bathing, washing, irrigation, etc., at the point of consumption instead of at a centralized location. Point-of-use treatment may include water treatment at a more decentralized level such as a small community or at a household. A drastic alternative is to abandon use of the contaminated aqueous solutions and use an alternative source.

Other methods are used for removing gasoline and fuel contaminants, and particularly the gasoline additive, MTBE. These methods include, for example, phytoremediation, soil vapor extraction, multiphase extraction, air sparging, membranes (reverse osmosis), and other technologies. In addition to high cost, some of these alternative remediation technologies result in the formation of other contaminants at concentrations higher than their recommended limits. For example, most oxidation methods of MTBE result in the formation of bromate ions higher than its recommended limit of 10 μg/L in drinking water (Liang et al., “Oxidation of MTBE by ozone and peroxone processes,” J. Am. Water Works Assoc. 91:104 (1999)). A number of technologies have proven useful in reducing MTBE contamination, including photocatalytic degradation with UV light and titanium dioxide (Barreto et al., “Photocatalytic degradation of methyl tert-butyl ether in TiO₂ slurries: a proposed reaction scheme,” Water Res. 29:1243-1248 (1995); Cater et al., UV/H₂O₂ treatment of MTBE in contaminated water,” Environ. Sci Technol. 34:659 (2000)), oxidation with UV and hydrogen peroxide (Chang and Young, “Kinetics of MTBE degradation and by-product formation during UV/hydrogen peroxide water treatment,” Water Res. 34:2223 (2000); Stefan et al., Degradation pathways during the treatment of MTBE by the UV/H₂O₂ process,” Environ. Sci. Technol. 34:650 (2000)), oxidation by ozone and peroxone (Liang et al., “Oxidation of MTBE by ozone and peroxone processes,” J. Am. Water Works Assoc. 91:104 (1999)) and in situ and ex situ bioremediation (Bradley et al., “Aerobic mineralization of MTBE and tert-Butyl alcohol by stream bed sediment microorganisms,” Environ. Sci. Technol. 33:1877-1879 (1999)). Use of TiO₂ as a photocatalyst has been shown to degrade a wide range of organic pollutants in water, including halogenated and aromatic hydrocarbons, nitrogen-containing heterocyclic compounds, hydrogen sulfide, surfactants, herbicides, and metal complexes (Matthews, “Photo-oxidation of organic material in aqueous suspensions of titanium dioxide,” Water Res. 220:569 (1986); Matthews, “Kinetic of photocatalytic oxidation of organic solutions over titanium-dioxide,” J. Catal. 113:549 (1987); Ollis et al., “Destruction of water contaminants,” Environ. Sci. Technol. 25:1522 (1991)).

Irradiation of a semiconductor photocatalyst, such as TiO₂, zinc oxide, or cadmium sulfide, with light energy equal to or greater than the band gap energy (Ebg) causes electrons to shift from the valence band to the conduction band. If the ambient and surface conditions are correct, the excited electron and hole pair can participate in oxidation-reduction reactions. The oxygen acts as an electron acceptor and forms hydrogen peroxide. The electron donors (i.e., contaminants) are oxidized either directly by valence band holes or indirectly by hydroxyl radicals (Hoffman et al., “Photocatalytic production of H₂O₂ and organic peroxide on quantum-sized semi-conductor colloids,” Environ. Sci. Technol. 28:776 (1994)). Additionally, ethers can be degraded oxidatively using a photocatalyst such as TiO₂ (Lichtin et al., “Photopromoted titanium oxide-catalyzed oxidative decomposition of organic pollutants in water and in the vapor phase,” Water Pollut. Res. J. Can. 27:203 (1992)). A reaction scheme for photocatalytically destroying MTBE using UV and TiO₂ has been proposed, but photodegradation took place only in the presence of catalyst, oxygen, and near UV irradiation and MTBE was converted to several intermediates (tertiary-butyl formate, tertiary-butyl alcohol, acetone, and alpha-hydroperoxy MTBE) before complete mineralization (Barreto et al. “Photocatalytic degradation of methyl tert-butyl ether in TiO₂ slurries: a proposed reaction scheme,” Water Res. 29:1243-1248 (1995)).

Furthermore, the most commonly used method of treating aqueous solutions for disinfection of microorganisms is chemically treating the solution with chlorine. Disinfection with chlorine, however, has several disadvantages. For example, chlorine content must be regularly monitored, formation of undesirable carcinogenic by-products may occur, chlorine has an unpleasant odor and taste, and requires the storage of water in a holding tank for a specific time period.

Accordingly, there is a need in the art for alternative approaches for treating aqueous solutions to reduce amounts of contaminants. Specifically, it would be advantageous to have methods for treating various aqueous solutions including groundwater, wastewater, drinking water, aquarium water, and aquaculture water to remove contaminants without the addition of chemical constituents, the production of potentially hazardous by-products, or the need for long-term storage.

### SUMMARY OF THE DISCLOSURE

The present disclosure is generally directed to methods of treating aqueous solutions to reduce amounts of contaminants. More specifically, one aspect of the invention is a photoelectrocatalytic composite photoanode for removing contaminants from aqueous solutions. The photoanode comprises a solid nanoporous film member having a median pore diameter in the range of 0.1-500 nanometers constructed from TiO₂ nanoparticles, the nanoporous film member adhered to a conductive support member.

In an exemplary embodiment of the photoelectrocatalytic composite photoanode, the median pore diameter is in the range of 0.3-25 nanometers.

In another exemplary embodiment of the photoelectrocatalytic composite photoanode, the median pore diameter is in the range of 0.3-10 nanometers.

In another exemplary embodiment of the photoelectrocatalytic composite photoanode, the nanoporous film member has an average thickness in the range of 1-2000 nm.

In another exemplary embodiment of the photoelectrocatalytic composite photoanode, the nanoporous film member has an average thickness in the range of 5 to 500 nm.

In another exemplary embodiment of the photoelectrocatalytic composite photoanode, the nanoporous film member is constructed from a stable, dispersed suspension comprising TiO₂ nanoparticles having a median primary particle diameter in the range of 1-50 nanometers. The nanoporous film may also be deposited by other methods, such as plasma, chemical vapor deposition or electrochemical oxidation.

In another exemplary embodiment of the photoelectrocatalytic composite photoanode, the TiO₂ nanoparticles have a median primary particle diameter in the range of 0.3-5 nanometers.

In another exemplary embodiment of the photoelectrocatalytic composite photoanode, the nanoporous film member is constructed from a stable, dispersed suspension further comprising a doping agent.

In another exemplary embodiment of the photoelectrocatalytic composite photoanode, the doping agent is Pt, Ni, Au, V, Sc, Y, Nb, Ta, Fe, Mn, Co, Ru, Rh, P, N or carbon.

In another exemplary embodiment of the photoelectrocatalytic composite photoanode, the conductive support member is annealed titanium foil. Modifications of the titanium foil that improve photoanode performance include making holes or perforations at regular intervals in the foil (about 0.5 cm to about 3 cm spacing between the holes), and corrugating the foil to produce a regular wave-like pattern on the foil surface. The height of a corrugation “wave” is about 1 mm to about 5 mm. Other conductive supports may be employed, such as conductive carbon or glass.

In another exemplary embodiment of the photoelectrocatalytic composite photoanode, the nanoporous film member is constructed by applying a stable, dispersed suspension having TiO₂ nanoparticles suspended therein, and, the TiO₂ nanoparticles are sintered at a temperature in the range of 300° C. to 1000° C. for 0.5 to 10 hours to produce the nanoporous film member.

In another exemplary embodiment of the photoelectrocatalytic composite photoanode, the stable, dispersed suspension is made by reacting titanium isopropoxide and nitric acid in the presence of ultrapure water or water purified by reverse osmosis, ion exchange, and one or more carbon columns.

In another exemplary embodiment of the photoelectrocatalytic composite photoanode, the photoelectrocatalytic composite photoanode is cylindrical in shape.

Another aspect of the invention is a photoelectrocatalytic oxidation device for use in an aquarium or aquaculture comprising any one of the above photoelectrocatalytic composite photoanodes, a cathode, a housing member having an inlet and outlet adapted to house the anode and cathode, a light source assembly adapted to emit ultraviolet light to the photoelectrocatalytic composite photoanode, and, an electrical power source adapted to apply a voltage across the photoelectrocatalytic composite photoanode and cathode in the range of −1 V to +12 V.

In an exemplary embodiment of the photoelectrocatalytic oxidation device, the cathode is constructed from Pt, Ti, Ni, Au, stainless steel or carbon.

In another exemplary embodiment of the photoelectrocatalytic oxidation device, the cathode is in the shape of a wire, plate or cylinder.

In another exemplary embodiment of the photoelectrocatalytic oxidation device, the device further comprises a reference electrode and a voltage control device, such as a potentiostat, adapted to maintain a constant voltage or constant current between the reference electrode and the photoelectrocatalytic composite photoanode, whereby the housing member is adapted to house the reference electrode.

In another exemplary embodiment of the photoelectrocatalytic oxidation device, the device further comprises a semi-micro saline bridge member connecting the potentiostat and reference electrode, whereby the housing member is adapted to house the saline bridge.

In another exemplary embodiment of the photoelectrocatalytic oxidation device, the reference electrode is constructed from silver and is in the shape of a wire.

In another exemplary embodiment of the photoelectrocatalytic oxidation device, the device further comprises a carbon filter adapted to filter chlorine from the water, and, a computer adapted to send a controlled signal to the existing power supplies to pulse the voltage and current.

In another exemplary embodiment of the photoelectrocatalytic oxidation device, the housing member is adapted to house the light source assembly and the electrical power source is adapted to generate an electrical potential in the range of 1.2 V to 3.5 V across the photoelectrocatalytic composite photoanode and cathode (or, 0 to 2.3 V vs the reference electrode).

Alternatively, the instant device may employ both constant current and/or constant voltage between anode and cathode. The effective voltage range may be in the range of −1 V to +12 V.

In another exemplary embodiment of the photoelectrocatalytic oxidation device, the light source assembly comprises a lamp or bulb and a transparent quartz or fused silica member adapted to house the lamp, and the ultraviolet light has a wavelength in the range of 200-380 nm. The device will also function using sunlight instead of the light source assembly.

In another exemplary embodiment of the photoelectrocatalytic oxidation device, the lamp is adapted to emit germicidal UVC or black light UVA.

In another exemplary embodiment of the photoelectrocatalytic oxidation device, the germicidal UVC emits a peak wavelength of 254 nm, and the black light UVA emits a wavelength in the range of 300-380 nm.

In another exemplary embodiment o the photoelectrocatalytic oxidation device, the lamp is a low pressure mercury vapor lamp adapted to emit UV germicidal irradiation at 254 nm wavelength.

In another exemplary embodiment of the photoelectrocatalytic oxidation device, the lamp is adapted to emit an irradiation intensity in the range of 1-500 mW/cm². The irradiation intensity varies considerably depending on the type of lamp used. Higher intensities improve the performance of the photoelectrocatalytic oxidation (PECO) device. The intensity can get so high that the system is swamped and no further benefit is obtained. That value depends upon the distance between the light and the photoanode.

In another exemplary embodiment of the photoelectrocatalytic oxidation device, the light source assembly is disposed exterior to the housing member, and the housing member further comprises a transparent member adapted to permit ultraviolet light emitted from the light source assembly to irradiate the photoelectrocatalytic composite photoanode.

Another aspect of the invention is a method of reducing the amount and concentration of ammonia in an aquarium or aquaculture comprising the steps or acts of providing an aqueous solution comprising water, NH₃, NH₄⁺ and 1 ppb to 200 g/L NaCl, and, photoelectrocatalytically oxidizing the NH₃ and NH₄⁺ to produce N₂ gas, NO₂⁻ and NO₃⁻.

In an exemplary embodiment of the method of reducing the amount and concentration of ammonia in an aquarium or aquaculture, the aqueous solution has a pH in the range of 5 to 10.

In another exemplary embodiment of the method of reducing the amount and concentration of ammonia in an aquarium or aquaculture, the aqueous solution comprises 1 to 41 g/L NaCl.

In another exemplary embodiment of the method of reducing the amount and concentration of ammonia in an aquarium or aquaculture, the aqueous solution comprises in the range of 0.05 ppb to 9 ppm NH₃ and NH₄⁺ as nitrogen.

In another exemplary embodiment of the method of reducing the amount and concentration of ammonia in an aquarium or aquaculture, NH₃ and NH₄⁺ are photoelectrocatalytically oxidized using a voltage in the range of −1 V to +12 V.

In another exemplary embodiment of the method of reducing the amount and concentration of ammonia in an aquarium or aquaculture, NH₃ and NH₄⁺ are photoelectrocatalytically oxidized using a voltage in the range of 1.2 to 3.5 V.

In another exemplary embodiment of the method of reducing the amount and concentration of ammonia in an aquarium or aquaculture, NH₃ and NH₄⁺ are photoelectrocatalytically oxidized using sunlight or ultraviolet light having a wavelength in the range of 200 to 380 nm.

In another exemplary embodiment of the method of reducing the amount and concentration of ammonia in an aquarium or aquaculture, the ultraviolet light is germicidal UVC having a peak wavelength of 254 nm or black light UVA having a wavelength in the range of 300-380 nm.

Another aspect of the invention is an aquarium comprising a fish tank and any one of the above photoelectrocatalytic oxidation devices.

Another aspect of the invention is a photoelectrocatalytic uncoated anode constructed from an anatase polymorph of Ti or a rutile polymorph of Ti.

In an exemplary embodiment of the photoelectrocatalytic uncoated anode, the uncoated anode is constructed from the rutile polymorph of Ti.

In another exemplary embodiment of the photoelectrocatalytic uncoated anode, the rutile polymorph of Ti is constructed by heating an anatase polymorph of Ti at a temperature in the range of 300° C. to 1000° C. for a sufficient time.

In another exemplary embodiment of the photoelectrocatalytic uncoated anode, the anatase polymorph of Ti is heated at 500° C. to 600° C. to produce the rutile polymorph of Ti.

In another exemplary embodiment of the photoelectrocatalytic uncoated anode, the uncoated anode is configured as a foil, with or without perforations and corrugations.

In another exemplary embodiment of the photoelectrocatalytic uncoated anode, the uncoated anode is further configured as cylindrical in shape. The foil conductive support member of the uncoated anode may be with or without perforations and corrugations.

Another aspect of the invention is a photoelectrocatalytic oxidation device for use in an aquarium or aquaculture comprising any one of the above photoelectrocatalytic uncoated anodes, a cathode, a housing member having an inlet and outlet adapted to house the uncoated anode and cathode, a light source assembly adapted to emit ultraviolet light to the photoelectrocatalytic uncoated anode, and, an electrical power source adapted to apply a voltage across the photoelectrocatalytic uncoated anode and cathode in the range of −1 to +12 V.

In an exemplary embodiment of the photoelectrocatalytic oxidation device, the cathode is constructed from Pt or Ti.

In another exemplary embodiment of the photoelectrocatalytic oxidation device, the cathode is constructed from Pt, Ti, Ni, stainless steel or carbon, and the cathode is in the shape of a wire or a plate or a cylinder.

In another exemplary embodiment of the photoelectrocatalytic oxidation device, the device further comprises a reference electrode and a potentiostat adapted to maintain a constant voltage between the reference electrode and the photoelectrocatalytic uncoated anode, and the housing member is adapted to house the reference electrode.

In another exemplary embodiment of the photoelectrocatalytic oxidation device, the device further comprises a semi-micro saline bridge member connecting the potentiostat and reference electrode, and the housing member is adapted to house the saline bridge.

In another exemplary embodiment of the photoelectrocatalytic oxidation device, the reference electrode is constructed from silver.

In another exemplary embodiment of the photoelectrocatalytic oxidation device, the reference electrode is in the shape of a wire.

In another exemplary embodiment of the photoelectrocatalytic oxidation device, the housing member is adapted to house the light source assembly, and the electrical power source is adapted to generate an electrical potential in the range of 1.2 to 3.5 V across the photoelectrocatalytic uncoated anode and cathode.

In another exemplary embodiment of the photoelectrocatalytic oxidation device, the light source assembly comprises a lamp or bulb and a transparent quartz or fused silica member adapted to house the lamp, and the ultraviolet light has a wavelength in the range of 200-380 nm.

In another exemplary embodiment of the photoelectrocatalytic oxidation device, the lamp is adapted to emit germicidal UVC or black light UVA.

In another exemplary embodiment of the photoelectrocatalytic oxidation device, the germicidal UVC emits a peak wavelength of 254 nm, and the black light UVA emits a wavelength in the range of 300-380 nm.

In another exemplary embodiment of the photoelectrocatalytic oxidation device, the lamp is a low pressure mercury vapor lamp adapted to emit UV germicidal irradiation at 254 nm wavelength.

In another exemplary embodiment of the photoelectrocatalytic oxidation device, the lamp is adapted to emit an irradiation intensity in the range of 1-500 mW/cm².

In another exemplary embodiment of the photoelectrocatalytic oxidation device, the light source assembly is disposed exterior to the housing member, and, the housing member further comprises a transparent member adapted to permit ultraviolet light emitted from the light source assembly to irradiate the photoelectrocatalytic uncoated anode.

Another aspect of the invention is a method of reducing the amount and concentration of ammonia in an aquarium or aquaculture comprising the steps or acts of providing an aqueous solution comprising water, NH₃ and NH₄⁺ and 1 ppb to 200 g/L NaCl, and, photoelectrocatalytically oxidizing the NH₃ and NH₄⁺ to produce N₂ gas (as well as insignificant amounts of some by-products such as NO₂⁻ and NO₃), wherein the NH₃ and NH₄⁺ are oxidized on (or proximate to) the surface of a photoanode constructed from an anatase polymorph of Ti, a rutile polymorph of Ti, or a nanoporous film of TiO₂.

In an exemplary embodiment of the method of reducing the amount and concentration of ammonia in an aquarium or aquaculture, the aqueous solution has a pH in the range of 5 to 10.

In another exemplary embodiment of the method of reducing the amount and concentration of ammonia in an aquarium or aquaculture, the aqueous solution comprises 1 to 41 g/L NaCl.

In another exemplary embodiment of the method of reducing the amount and concentration of ammonia in an aquarium or aquaculture, the aqueous solution comprises in the range of 0.05 ppb to 9 ppm NH₃ and NH₄⁺ as nitrogen.

In another exemplary embodiment of the method of reducing the amount and concentration of ammonia in an aquarium or aquaculture, NH₃ and NH₄⁺ are photoelectrocatalytically oxidized by a voltage in the range of −1 V to +12 V.

In another exemplary embodiment of the method of reducing the amount and concentration of ammonia in an aquarium or aquaculture, NH₃ and NH₄⁺ are photoelectrocatalytically oxidized using a voltage in the range of 1.2 to 3.5 V.

In another exemplary embodiment of the method of reducing the amount and concentration of ammonia in an aquarium or aquaculture, NH₃ and NH₄⁺ are photoelectrocatalytically oxidized using sunlight or ultraviolet light having a wavelength in the range of 200 to 380 nm.

In another exemplary embodiment of the method of reducing the amount and concentration of ammonia in an aquarium or aquaculture, the ultraviolet light is germicidal UVC having a peak wavelength of 254 nm or black light UVA having a wavelength in the range of 300-380 nm.

Another aspect of the invention is a photoelectrocatalytic oxidation device for use in an aquarium or aquaculture comprising any one of the photoelectrocatalytic composite photoanodes or uncoated anodes above, a cathode, a housing member having an inlet and outlet adapted to house the anode and cathode, and, an electrical power source adapted to apply a voltage across the photoelectrocatalytic composite photoanode and cathode in the range of −1 V to +12 V, wherein the housing is adapted to permit sunlight to illuminate both the anode or a solar cell adapted to provide the voltage applied across the photoelectrocatalytic composite photoanode and cathode.

Another aspect of the invention is an aquarium containing a fish tank and any one of the above photoelectrocatalytic oxidation devices.

Another aspect of the invention is a closed, recirculating aquaculture system containing any one of the above photoelectrocatalytic oxidation devices.

In another aspect, the present disclosure is directed to methods of treating an aqueous solution having one or more contaminants therein to reduce the amounts of contaminants. The method comprises providing an aqueous solution comprising at least one contaminant selected from the group consisting of an organism, an organic chemical, an inorganic chemical, and combinations thereof and exposing the aqueous solution to photoelectrocatalytic oxidization, wherein one or more contaminant is oxidized by a free radical produced by a photoanode, wherein the photoanode comprises an anatase polymorph of titanium, a rutile polymorph of titanium, or a nanoporous film of titanium dioxide.

In another aspect, the present disclosure is directed to methods of environmental remediation, the method comprising providing a sample of environmental medium comprising at least one contaminant selected from the group consisting of an organism, an organic chemical, an inorganic chemical, and combinations thereof and exposing the sample of an environmental medium to photoelectrocatalytic oxidization, wherein one or more contaminant is oxidized by a free radical produced by a photoanode, wherein the photoanode comprises an anatase polymorph of titanium, a rutile polymorph of titanium, or a nanoporous film of titanium dioxide.

In another aspect, the present disclosure is directed to methods of treating an aqueous solution having one or more contaminants therein to reduce the amounts of contaminants. The method comprises providing an aqueous solution comprising at least one contaminant selected from the group consisting of an organism, an organic chemical, an inorganic chemical, and combinations thereof and exposing the aqueous solution to photoelectrocatalytic oxidization, wherein one or more contaminant is oxidized by a chlorine atom produced by a photoanode, wherein the photoanode comprises an anatase polymorph of titanium, a rutile polymorph of titanium, or a nanoporous film of titanium dioxide.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 is an electrochemical energy schematic graphically illustrating one embodiment of the photoelectrocatalytic oxidation (PECO) device of the instant invention showing oxidation of ammonia to nitrogen gas, whereby UV light of sufficient energy illuminates a photoanode including a nanoporous titanium dioxide (TiO₂) photocatalyst film coated to a Ti support, whereby electrons in the valence band (VB) are excited into the conduction band (CB) producing highly reactive electrons and holes that promote oxidation of ammonia on the anode surface, whereby the photogenerated electrons preferentially flow to the cathode reducing protons and producing hydrogen gas (H₂) and/or reducing oxygen gas (O₂) and producing water, whereby ΔGₐ is the minimum energy required for the activation of NH₃, whereby ΔG_{cell} is the maximum energy obtained by the device when. ΔGₐ is applied, whereby A=applied voltage via a potentiostat, and, whereby the PECO device may include a reference electrode (not pictured).

FIG. 2 shows one embodiment of the PECO device of the present invention being a cylindrical flow-through configuration, whereby the device may also be referred to as a photoelectrocatalytic cell.

FIG. 3 is a graphical illustration of a nitrogen cycle for conventional biofiltration systems.

FIG. 4 is another illustration of photoelectrocatalytic oxidation (General for PCO).

FIG. 5 is a graph showing photocurrent generation as a function of applied potential demonstrating flat band potential of the instant TiO₂-coated Ti composite photoanode (“composite photoanode”) at various initial pH values (pH 4, pH 7 and pH 10) in NaCl solution (4 g/L), whereby linear sweep Vammetry (LSV) triplicate experiment parameters included −1.0 to +1.0 V vs SCE, scan rate 20 mV/s, scan increment of 2.0 mV, step time 0.1 s, and, full spectrum light intensity at 1 W/cm², and whereby control experiments without irradiation produced no current generation.

FIG. 6 is a graph showing ammonia-nitrogen removal as a function of NaCl concentration (0, 0.001, 0.1, 0.25, 1 and 31 g/L)(initial pH 7) using the instant PECO device shown in FIG. 1, whereby triplicate chronoamperometry experiments were conducted, whereby the initial concentration of NH₄⁺ was 0.54 mg/L, whereby the applied potential was +1.0 V vs SCE, and, whereby the composite photoanode was irradiated with full spectrum light intensity at 1.09 W/cm².

FIG. 7 is a graph showing ammonia-nitrogen removal at various light intensities (1.09, 0.60, 0.30 and 0.06 W/cm²) using the instant PECO device shown in FIG. 1, whereby the initial concentration of NH₄⁺ was 0.54 mg/L in 31 g NaCl/L (initial pH 7)(triplicate experiments), whereby full spectrum light was applied, and, whereby the applied potential was +1.0 V vs SCE. The amount of byproducts generated during this test is shown in Table 2.

FIG. 8 is a graph showing ammonia removal from freshwater using the instant PECO device shown in FIG. 1, whereby deionized freshwater (pH 7.4) was spiked with 5 mg/L ammonium chloride, whereby control conditions were the same as the experimental conditions except that photoanode illumination and electric potential were not applied, whereby replicate experiments were performed (N=2 for the controls and N=3 for the experimental), whereby the data shown are the means±standard error of the mean, and whereby the y-axis is the percent of the initial ammonia concentration that remains in the solution at the time shown.

FIG. 9 is a graph showing ammonia removal from salt water using the instant PECO device shown in FIGS. 1 and 2, whereby the y-axis is the decimal fraction of the initial concentration of ammonia that remains in the solution at the time shown.

FIG. 10 is a graph showing ammonia removal using the instant composite photoanode in a static reactor at various number of applied coatings (translating into various film thicknesses) and sintering temperatures of the nanoporous TiO₂ film, whereby the Ti photoanode supports were dip-coated 0, 3 or 5 times in a titania sol and sintered at 300° C. or 500° C., whereby approximately 80 nm to 130 nm TiO₂ is deposited on the titanium support per dip-coating, whereby the experiment was conducted in water containing 1 gram of NaCl per liter of fresh water with aeration, whereby the applied voltage was +1.0 V, whereby the data shown are mean±SEM (N=4), and, whereby the amount of ammonia remaining at given times during the 30-minute tests is shown. (All data reported in FIGS. 10-15 were conducted in freshwater).

FIG. 11 is a bar graph showing nitrate production using the instant composite photoanode in a static reactor at various film thicknesses and sintering temperatures of the nanoporous TiO₂ film, whereby the Ti photoanode supports were dip-coated 0, 3 or 5 times in a titania sol and sintered at 300° C. or 500° C., whereby the experiment was conducted in 100% fresh water (pH 7) with aeration, whereby the applied voltage was +1.0 V, and, whereby the data shown are mean±SEM (N=4).

FIG. 12 is a graph showing ammonia removal using the instant composite photoanode in a static reactor at various film thicknesses and sintering temperatures of the nanoporous Pt-doped TiO₂ film, whereby the Ti photoanode supports were dip-coated 3 or 5 times in a titania sol containing 1% platinum (Pt) and fired at 300° C. or 500° C., whereby the experiment was conducted in 100% fresh water (pH 7) with aeration, whereby the applied voltage was +1.0 V, and, whereby the data shown are mean±SEM (N=4).

FIG. 13 is a bar graph showing nitrate production using the instant composite photoanode in a static test reactor at various film thicknesses and sintering temperatures of the nanoporous Pt-doped TiO₂ film, whereby the Ti photoanode supports were dip-coated 3 or 5 times in a titania sol containing 1% platinum (Pt) and fired at 300° C. or 500° C., whereby the experiment was conducted in 100% fresh water (pH 7) with aeration, whereby the applied voltage was +1.0 V, and, whereby the data shown are mean±SEM (N=4).

FIG. 14 is a graph showing ammonia removal using the instant composite photoanode in aerated and non-aerated (i.e., static) test reactors containing 100% fresh water (pH 7) at various film thicknesses of nanoporous TiO₂, whereby the Ti photoanode supports were dip-coated 3 or 5 times in a titania sol and sintered at 500° C., and, whereby the applied voltage was +1.0 V (N=1).

FIG. 15 is a bar graph showing ammonia removal using the instant composite photoanode in a test reactor with stirring, air aeration, argon gas bubbling or static (control), whereby stirring was accomplished using a magnetic stir bar, whereby the uncoated Ti photoanode supports were dip-coated 3 times in a titania sol and sintered at 500° C., whereby the y-axis shows the concentration of ammonia (as N) remaining in solution after 3 minutes of reaction, whereby the experiment was conducted in 100% fresh water (pH 7), whereby the applied voltage was +1.0 V and N=1, and, whereby the y-axis is Ammonia Conc. (ppm as N).

FIG. 16 is a graph showing ammonia removal using uncoated Ti photoanode supports fired at 500° C. theoretically converting the Ti to a rutile polymorph in test reactors, whereby the initial ammonia concentration was 9 ppm ammonia as nitrogen, whereby the experiment was conducted in 100% seawater with aeration, whereby the applied voltage was +1.0 V, and, whereby the data shown are the results of 2 independent experiments.

FIG. 17 is a graph showing ammonia removal using uncoated Ti photoanode supports fired at 500° C. in test reactors, whereby the experiment was conducted in 100% seawater (INSTANT OCEAN) and freshwater containing 1 g/L NaCl, whereby both waters were aerated, whereby the applied voltage was +1.0 V, and, whereby the data shown are mean±SEM (N=3).

FIG. 18 is a graph showing ammonia removal using uncoated Ti photoanode supports fired at 500° C. in test reactors at various water pH values (pH 5 and pH 10) in test reactors, whereby the experiment was conducted in freshwater containing 1 g/L NaCl, whereby the water was aerated, whereby the applied voltage was +1.0 V, whereby the data shown are mean±SEM (N=3), whereby the pH was adjusted using sodium hydroxide or hydrochloric acid as needed, and, whereby controls were conducted with UV lights on, but no applied voltage.

FIG. 19 is a graph showing ammonia removal using uncoated Ti photoanode supports fired at 500° C. in test reactors at various applied voltages with respect to the reference electrode (WRT Reference), whereby the experiment was conducted in freshwater containing 1 g/L NaCl (pH 7), whereby water was aerated, whereby the applied voltage to the uncoated Ti photoanode support was 0, 0.3, 0.6, or 0.9 V WRT Reference, and, whereby the data shown are mean±SEM (N=3).

FIG. 20 is a bar graph showing nitrite and nitrate production using uncoated Ti photoanode supports fired at 500° C. in batch test reactors at various voltages applied between the uncoated Ti foil photoanode support and a silver wire reference, whereby the test solution consisted of 1.6 mg/L NH₄Cl in 1 g/L NaCl, whereby a potential difference of +1.0 V was maintained between the reference electrode and the photoanode, and whereby each point is an average of four replicate measurements.

FIG. 21 is a graph showing ammonia removal using the instant PECO device shown in FIGS. 1 and 2, whereby the experiment was conducted in freshwater containing 1 g/L NaCl (pH 7), whereby the water was aerated, whereby the applied voltage in the 2-electrode system was 2.2 V between the anode and cathode, whereby the applied voltage in the 3-electrode system was 1 V between the anode and reference electrode (2.2 V between the anode and cathode), and, whereby N=1.

FIG. 22 shows ammonia removal from water using the instant flow-through PECO device shown in FIGS. 1 and 2, whereby the experiment was conducted in 100% seawater, whereby the water volume was 7 liters (pH 7), whereby the water was aerated, whereby the applied voltage was +1 V, and whereby the data shown are results of two independent trials.

FIG. 23 is an electrical circuit diagram of the electrical components used in the instant invention, whereby the electrical circuit is a power supply that provides a user-selectable constant voltage and allows for a range of current (electrical load) varying between 0 and 500-1,000 mA, and whereby the circuit can be internally or externally driven by a computer-based or machine-based controller to allow for pulsing the voltage at a wave-form, frequency, and time (on/off) periods found to be optimal per the needs of an application.

FIG. 24A is a graph showing the reduction of bisphenol-A over time as measured in Example 4.

FIG. 24B is a graph showing chlorine production over time as measured in Example 4.

FIG. 25A is a graph showing E. coli inactivation as measured in Example 5.

FIG. 25B is a graph showing MS2 coliphage inactivation as measured in Example 5.

FIG. 26 is a graph showing the reduction of benzene, toluene, and ethylbenzene over time as measured in Example 6.

FIG. 27 is a graph showing the reduction of benzene, toluene, ethylbenzene, and xylenes over time as measured in Example 6.

FIG. 28 is a graph showing the reduction of MTBE over time as measured in Example 7.

FIG. 29 is a graph showing the reduction of gasoline constituents over time as measured in Example 8.

FIG. 30 is a graph showing the reduction of benzene, acetone, BDM, chloroform, and chloromethane over time as measured in Example 9.

FIG. 31A is a graph showing the reduction of phenoxyacetic acid over time as measured in Example 10.

FIG. 31B is a graph showing the concentration of chlorine as measured in Example 10.

FIG. 32 is a graph showing the reduction of phenol over time as measured in Example 11.

FIG. 33A is a graph showing the reduction of carbamazepine over time as measured in Example 12.

FIG. 33B is a graph showing the concentration of chlorine as measured in Example 12.

FIG. 34A is a graph showing the reduction of triclosan over time as measured in Example 13.

FIG. 34B is a graph showing the concentration of chlorine as measured in Example 13.

FIG. 35 is a graph showing chlorine production as a function of NaCl concentration using a 9-watt, flow-through photoelectrocatalytic oxidation device with 7 liters of water and an applied voltage of +5 volt as measured in Example 14.

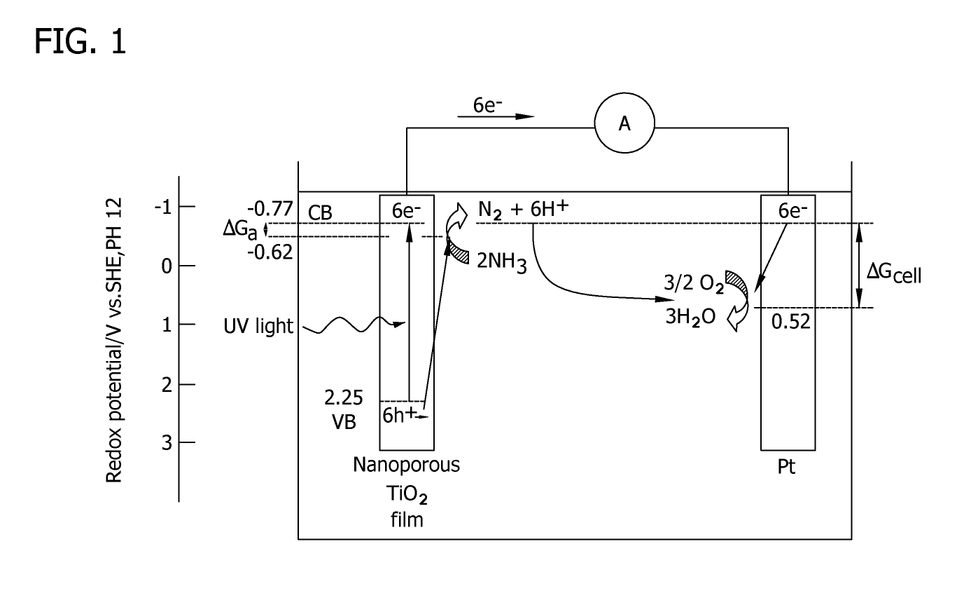

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein may be used in the practice or testing of the present disclosure, suitable methods and materials are described below.

The instant invention will improve aquaculture production and increase export of U.S.-produced seafood products, particularly high value products that are difficult to produce in developing countries such as lobsters and carnivorous fish species. The instant invention will also expand recirculation aquaculture production, increase the efficiency of agricultural production, and expand economic opportunities. Growth of the U.S. aquaculture industry will expand economic opportunities in the rural U.S. New recirculation aquaculture facilities will begin supplying fish to large existing markets.

The instant invention will also reduce the number and severity of agriculture pest and disease outbreaks in aquaculture. The instant invention will ensure access to nutritious food. Supporting the development and expansion of the U.S. aquaculture industry will enhance the U.S. fish supply, which is a key component of a healthy diet. Growing demand for seafood products will also be satisfied by the instant invention. The instant invention will also protect watershed health to ensure clean and abundant water, and protect and enhance wildlife habitat to benefit desired, at-risk and declining species.

Fish are very susceptible to ammonia and nitrite toxicity. Ammonia concentrations as low as 0.025 mg/L (ppm) can kill some sensitive fish species. Some robust fish species may also die from exposure to ammonia concentrations as low as 0.2 to 0.5 mg/L. Nitrite concentrations as low as 0.1 mg/L can also kill some fish species. The temperature and pH of the water also influences fish morbidity and survival. (Randall D et al., 2002, Ammonia toxicity in fish, Mar. Pollut. Bull. 45:17-23).

In aqueous ammonia-containing solutions, NH₄⁺ ions are in equilibrium with non-ionized NH₃. The non-ionized form of ammonia, NH₃ is a potent neurotoxin to fish, and it readily diffuses across fish gill membranes. (Tomasso J, 1994, Toxicity of nitrogeneous wastes to aquaculture animals, Rev. Fish. Sci. 2:291-314). The pKₐ at equilibrium is 9.3, therefore, ammonia is more toxic to fish at higher pH values.

Nitrite is also highly toxic to fish. Nitrite levels as low as 0.1 mg/L can kill some fish specie. (Russo R et al., 1991, Toxicity of ammonia, nitrite and nitrate to fishes, Aquaculture and water quality, eds. E. Brune & J. Tomasso, pp. 58-89). By comparison, nitrate is considerably less toxic to fish than ammonia. However, nitrate can negatively impact fish health at levels around 40-50 mg/L. (Russo et al., 1991; and Ip Y et al., 2001, Ammonia toxicity, tolerance and excretion, Fish Physiology eds. P. Wright & P. Anderson, pp. 109-148, Academic Press, San Diego).

The instant PECO device oxidizes a significant and substantial portion of ammonia to nitrogen gas. The instant PECO device also oxidizes trace-level organic contaminants (e.g., endocrine disrupters, PBDEs), disease-causing microorganisms (e.g., Eschricia coli), and potential biological and chemical threat agents (e.g., G- and V-series nerve agents, brucellosis, ricin). Photoelectrocatalytic oxidation is very effective at destroying pathogens in water. Photoelectrocatalytic oxidation also reduces the incidence of disease outbreaks that occur in recirculation aquaculture systems and facilities.

Other aqueous solutions that may be treated with the PECO device include groundwater, wastewater, drinking water, aquarium water, ballast water, and aquaculture water. Groundwater includes water that occurs below the surface of the Earth, where it occupies spaces in soils or geologic strata. Groundwater may include water that supplies aquifers, wells and springs.

Wastewater may be any water that has been adversely affected in quality by effects, processes, and/or materials derived from human activities. Wastewater may be water used for washing, flushing, or in a manufacturing process, that contains waste products. Wastewater may further be sewage that is contaminated by feces, urine, bodily fluids and/or other domestic, municipal or industrial liquid waste products disposed of via a pipe, sewer, or similar structure or infrastructure or via a cesspool emptier. Wastewater may originate from blackwater, cesspit leakage, septic tanks, sewage treatment, washing water (also referred to as “graywater”), rainfall, groundwater infiltrated into sewage, surplus manufactured liquids, road drainage, industrial site drainage, and storm drains, for example.

Drinking water includes water intended for supply to households, commerce and industry. Drinking water may include water drawn directly from a tap or faucet. Drinking water may further include sources of drinking water supplies such as, for example, surface water and groundwater.

Ballast water includes freshwater and seawater held in tanks and cargo holds of ships to increase the stability and maneuverability during transit. Ballast water may also contain exotic species, alien species, invasive species, and nonindiginous species and sediments.

Aquarium water includes freshwater, seawater, and saltwater used in water-filled enclosures in which fish or other aquatic plants and animals are kept. Aquarium water may originate from aquariums of any size such as small home aquariums up to large aquariums holding thousands to hundreds of thousands of gallons of water.

Aquaculture water is water used in the cultivation of aquatic organisms. Aquaculture water includes freshwater, seawater, and saltwater used in the cultivation of aquatic organisms.

The contaminant may be an organism, an organic chemical, an inorganic chemical, and combinations thereof. Specifically, “contaminant” refers to any compound that is not naturally found in the aqueous solution. Also included are microorganisms that may be naturally found in the aqueous solution and may be considered safe at lower levels, but may present disease and/or other health problems at higher levels. In the case of ballast water, also included are microorganisms that may be naturally found in the ballast water at its point of origin, but may be considered non-native or exotic species. Moreover, governmental agencies such as the United States Environmental Protection Agency, have established standards for contaminants in water.

In one aspect, the contaminant may be an organism. In some embodiments, the organism is a microorganism. The microorganism may be at least one of a prokaryote, a eukaryote, and a virus. The prokaryote may be, for example, pathogenic prokaryotes and fecal coliform bacteria. Exemplary prokaryotes may be Escherichia, Brucella, Legionella, and combinations thereof.

In some embodiments, the contaminant may include eukaryotes. Exemplary eukaryotes may be a protist, a fungus, or an alga. Exemplary protists (protozoans) may be Giardia, Cryptosporidium, and combinations thereof. The eukaryote may also be a pathogenic eukaryote. Also contemplated within the disclosure are cysts of cyst-forming eukaryotes such as, for example, Giardia.

In other embodiments, the contaminant may be a virus. Exemplary viruses may be a waterborne virus such as, for example, enteric viruses, hepatitis A virus, hepatitis E virus, rotavirus, and MS2 coliphage, adenovirus, and norovirus.

The eukaryote may also include disease vectors. A “disease vector” refers to an insect, nematode, or other organism that transmits an infectious agent. The life cycle of some invertebrates such as, for example, insects, includes time spent in water. Female mosquitoes, for example, lay their eggs in water. Other invertebrates such as, for example, nematodes, may deposit eggs in aqueous solutions. Cysts of invertebrates may also contaminate aqueous environments. Treatment of aqueous solutions in which a vector may reside may thus serve as a control mechanism for both the disease vector and the infectious agent.

In one aspect, the contaminant may include an organic chemical. The organic chemical may be any carbon-containing substance according to its ordinary meaning. The organic chemical may be chemical compounds, pharmaceuticals, over-the-counter drugs, dyes, agricultural pollutants, industrial pollutants, proteins, endocrine disruptors, fuel oxygenates, and personal care products. Exemplary organic chemicals may include acetone, acid blue 9, acid yellow 23, acrylamide, alachlor, atrazine, benzene, benzo(a)pyrene, bromodichloromethane, carbofuran, carbon tetrachloride, chlorobenzene, chlorodane, chloroform, chloromethane, 2,4-dichlorophenoxyacetic acid, dalapon, 1,2-dibromo-3-chloropropane, o-dichlorobenzene, p-dichlorobenzene, 1,2-dichloroethane, 1,1-dichloroethylene, cis-1,2-dichloroethylene, trans-1,2-dichloroethylene, dichlormethane, 1,2-dichloropropane, di(2-ethylhexyl) adipate, di(2-ethylhexyl) phthalate, dinoseb, dioxin (2,3,7,8-TCDD), diquat, endothall, endrin, epichlorohydrin, ethylbenzene, ethylene dibromide, glyphosate, a haloacetic acid, heptachlor, heptachlor epoxide, hexachlorobenzene, hexachlorocyclopentadiene, lindane, methyl-tertiary-butyl ether, methyoxychlor, napthoxamyl (vydate), naphthalene, pentachlorophenol, phenol, picloram, isopropylbenzene, N-butylbenzene, N-propylbenzene, Sec-butylbenzene, polychlorinated biphenyls (PCBs), simazine, sodium phenoxyacetic acid, styrene, tetrachloroethylene, toluene, toxaphene, 2,4,5-TP (silvex), 1,2,4-trichlorobenzene, 1,1,1-trichloroethane, 1,1,2-trichloroethane, trichloroethylene, a trihalomethane, 1,2,4-trimethylbenzene, 1,3,5-trimethylbenzene, vinyl chloride, o-xylene, m-xylene, p-xylene, an endocrine disruptor, a G-series nerve agent, a V-series nerve agent, bisphenol-A, bovine serum albumin, carbamazepine, cortisol, estradiol-17β, gasoline, gelbstoff, triclosan, ricin, a polybrominated diphenyl ether, a polychlorinated diphenyl ether, and a polychlorinated biphenyl. Methyl tert-butyl ether (also known as, methyl tertiary-butyl ether) is a particularly suitable organic chemical contaminant.

In one aspect, the contaminant may include an inorganic chemical. As defined herein, “inorganic chemical” includes nitrogen-containing inorganic chemicals such as, for example, ammonia (NH₃) or ammonium (NH₄) as described above, and non-nitrogen-containing inorganic chemicals. Non-nitrogen-containing inorganic chemicals include, for example, aluminum, antimony, arsenic, asbestos, barium, beryllium, bromate, cadmium, chloramine, chlorine, chlorine dioxide, chlorite, chromium, copper, cyanide, fluoride, iron, lead, manganese, mercury, nickel, nitrate, nitrite, selenium, silver, sodium, sulfate, thallium, and zinc.

In one aspect, the contaminant may include a radionuclide. Radioactive contamination may be the result of a spill or accident during the production or use of radionuclides (radioisotopes). Exemplary radionuclides include an alpha photon emitter, a beta photon emitter, radium 226, radium 228, and uranium.

Without being bound to any single theory, it is hypothesized that the photoelectrocatalytic oxidation device including the composite photoanode performs photoelectrocatalytic oxidation of ammonia according to the following reactions (also referred to as break point chlorination):

2Cl^{-→Cl}₂+2e⁻ (I)

Cl₂+H₂O→HClO++Cl⁻+H⁺ (II)

2NH₄⁺+3HClO→N₂+2H₂O+5H+3Cl⁻ (III)

With the production of chlorine, it is also possible for this process to produce chloroamine compounds.

Without being bound to any single theory, it has been hypothesized that purely photocatalytic oxidation systems are effective because the process generates hydroxy radicals. If hydroxyl radicals are also generated in the instant photoelectrocatalytic oxidation process, the generated hydroxyl radical is a general oxidizing agent, therefore, other contaminants will also be oxidized. In particular, dissolved organic species are oxidized to water, carbon dioxide, and halide ions during photoelectrocatalytic oxidation. Dissolved metals having suitable reduction potentials are reduced and deposited/adhered to the metal cathode.

Additionally, the chlorine and hydroxyl radicals produced will move into the bulk aqueous solution. As a result, contaminants will also be destroyed by chlorine and hydroxyl radicals that have moved into the bulk aqueous solution.

In addition, the photoanode can also react with hydroxide ions (OH) and produce OH radicals. The generated hydroxyl radical is a general oxidizing agent; therefore, other contaminants will also be oxidized. In particular, dissolved organic species are oxidized to water, carbon dioxide, and halide ions during photoelectrocatalytic oxidation. Dissolved metals having suitable reduction potentials are reduced and deposited at the cathode.

### Methods for Treating Aqueous Solutions

One particular objective of the instant invention is to use photoelectrocatalysis as an ammonia treatment method for recirculating aquaculture systems. While described herein as removing ammonia from aquaculture systems, it should be understood by one skilled in the art that photoelectrocatalysis of other contaminants can be performed similarly using the PECO device.

The instant invention utilizes photoelectrocatalytic oxidation, whereby a photocatalytic composite photoanode is combined with a cathode to form an electrolytic cell. When the instant composite photoanode is illuminated by UV light, its surface becomes highly oxidative. By controlling variables such as chloride concentration, light intensity, pH and applied potential, the irradiated and biased TiO₂ composite photoanode selectively oxidizes ammonia that comes into contact with the surface, forming harmless nitrogen gas, whereby little or no other nitrogen compounds (e.g., nitrite) are formed as by-products. Application of a potential to the composite photoanode provides further control over the oxidation products.

PECO is an elegant, efficient, and economical solution to the problem of nitrogenous waste removal from water. Nitrite and ammonia are rapidly oxidized by PECO, and PECO uses very little energy. (Sun C C et al., 1998, Kinetics and mechanism of photoelectrochemical oxidation of nitrite ion by using the rutile form of a TiO₂/Ti photoelectrode with high electric field enhancement, Industrial & Engineering Chemistry Research 37:4207-4214; and, Kaneko M et al., 2006). PECO also produces few, if any, secondary metabolites such as chlorine. The nanoporous electrodes used in the instant invention are cost effective to manufacture and operate.

The instant composite photoanode is constructed from a conductive metal electrode being a Ti foil support coated with a thin layer (200-500 nm, hypothetical) of a titanium dioxide (TiO₂) that functions as a photocatalyst. The TiO₂ photocatalyst is illuminated with light having sufficient near UV energy generating highly reactive electrons and holes promoting oxidation of compounds on the anode surface. (Candal R J et al., 1998, TiO₂-mediated photoelectrocatalytic purification of water, J. Adv. Oxidat. Technol. 3:270-276; Candal R J et al., 1999, Titanium-supported titania photoelectrodes made by sol-gel processes, J. Environmental Engineering 125:906-912; Candal R J et al., 2000, Effects of pH and applied potential on photocurrent and oxidation rate of saline solutions of formic acid in a photoelectrocatalytic reactor, Environ. Sci. Technol. 34:3443-3451).

After the titanium support was coated with a thin film of TiO₂, the composite electrode was air-heated at a high temperature. The nanoporous TiO₂ film has a crystalline structure due to thermal oxidation. It is believed that the instant titania, when heated at 500° C., converts to a crystalline rutile polymorph structure. It is further believed that the instant TiO₂ heated at 300° C. converts to a crystalline anatase polymorph structure. In some PECO applications, rutile TiO₂ has substantially higher catalytic activity than the anatase TiO₂. Rutile TiO₂ may also have substantially higher catalytic activity with respect to ammonia.

Exemplary photoanodes may be prepared by coating Ti metal foil being 15 cm×15 cm×0.050 mm thickness and 99.6+% pure from Goodfellow Corp., Oakdale, Pa., with a titania-based metal oxide. The Ti foil was cleaned with a detergent solution, rinsed with deionized water, rinsed with acetone, and heat-treated at 350° C. for 4 hours providing an annealed Ti foil. Annealing may also be conducted at higher temperatures such as 500° C.

Following that pretreatment, the metal foil was dip-coated three or five times with an aqueous suspension of titania at a withdrawal rate of ˜3.0 mm/sec. After each application of coating, the coated foil was air dried for 10-15 min and then dried in an oven at 70° C. or 100° C. for 45 min. After applying the final coating, the coated foil was sintered at 300° C., 400° C. or 500° C. for 4 hr at a 3° C./min ramp rate. Uncoated Ti metal foil was similarly heat-treated and fired at 500° C. The Ti foil may be dipped into suspensions of titania synthesized using methods disclosed in commonly-owned U.S. patent application Ser. Nos. 11/932,741 and 11/932,519, which are incorporated herein by reference. The optimized withdrawal speed is around 21.5 cm min⁻¹. Titanium foil was very stable, and can also be used to make active photoelectrodes.

Modifications of the titanium foil that improve photoanode performance include making holes or perforations at regular intervals in the foil (about 0.5 cm to about 3 cm spacing between the holes), and corrugating the foil to produce a regular wave-like pattern on the foil surface. The height of a corrugation “wave” is about 1 mm to about 5 mm. In one embodiment, the foil is corrugated twice at right angles to each other producing a unique cross-hatched pattern on the foil surface. This embodiment of the photoanode has superior performance to foils with a singular wave pattern or no corrugations at all. Further, anodes have regularly spaced perforations and a cross-hatched corrugation pattern are particularly suitable.

Photocatalytic efficiency is significantly improved by applying a positive potential (i.e., bias) across the photoanode decreasing the recombination rate of photogenerated electrons and holes. The TiO₂ layer also significantly impacts the photoelectrocatalytic properties of the anode. Once TiO₂ is applied to the support structure, it is heated to a high temperature producing a crystalline structure via thermal oxidation. It is hypothesized that titanium heated at 500° C. has a rutile crystal polymorph structure. Titanium heated at lower temperatures (e.g., 300° C.) has an anatase polymorph structure. In one photoelectrocatalytic application, it has been reported that rutile films demonstrate significantly higher catalytic activity than anatase films. (Candal et al., 1999).

In particular, dissolved organic species are oxidized to water, carbon dioxide (CO₂), and halide ions (e.g., Cl⁻) during PECO. Dissolved metals having appropriate reduction potentials are reduced and deposited on the metal cathode. Several operating parameters influence these reactions, such as current density, pH, chloride concentration, and the presence of other anions such as SO₄²⁻, PO₄³⁻, NO₃⁻ and CO₃²⁻.

The instant PECO device also removes proteins from aquarium or aquaculture water. Dissolved organics (including proteins) can accumulate in water and degrade water quality. Most salt water aquaria are equipped with a protein skimmer for removing dissolved organics and proteins. Such organic material often has a yellowish tint and is sometimes called “gelbstoff” (German for yellow stuff). The PECO device was used for 45 mins to treat water spiked with a known concentration of protein being bovine serum albumin. No protein remained in the treated water.

In another experiment, water was spiked with gelbstoff collected from a saltwater aquarium. Using the instant PECO device, the gelbstoff was completely oxidized upon treatment overnight. The treated water was free of gelbstoff and perfectly clear as measured using a wavelength of 600 nm in a microplate spectrophotometer. Protein concentrations fell from over 25 μg/ml to 0 in the same time.

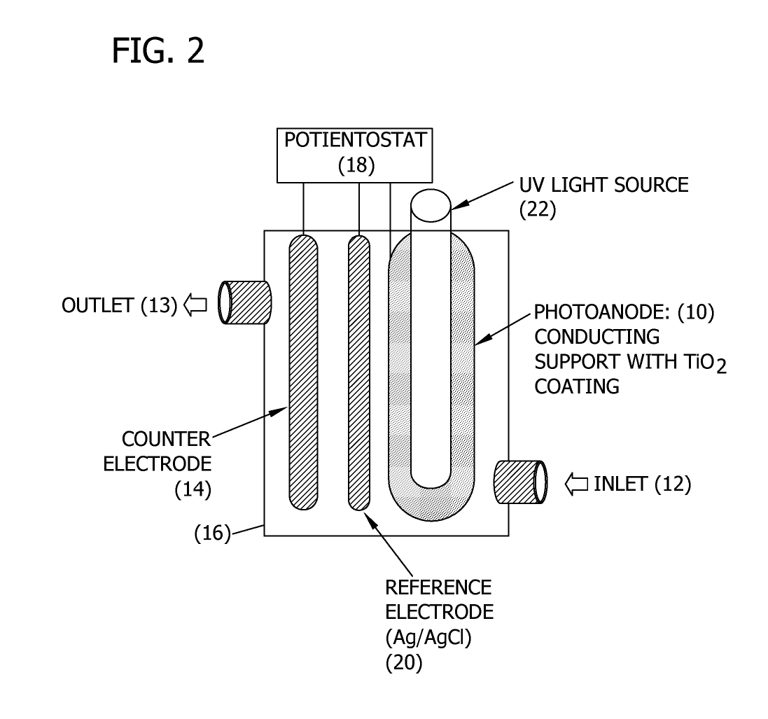

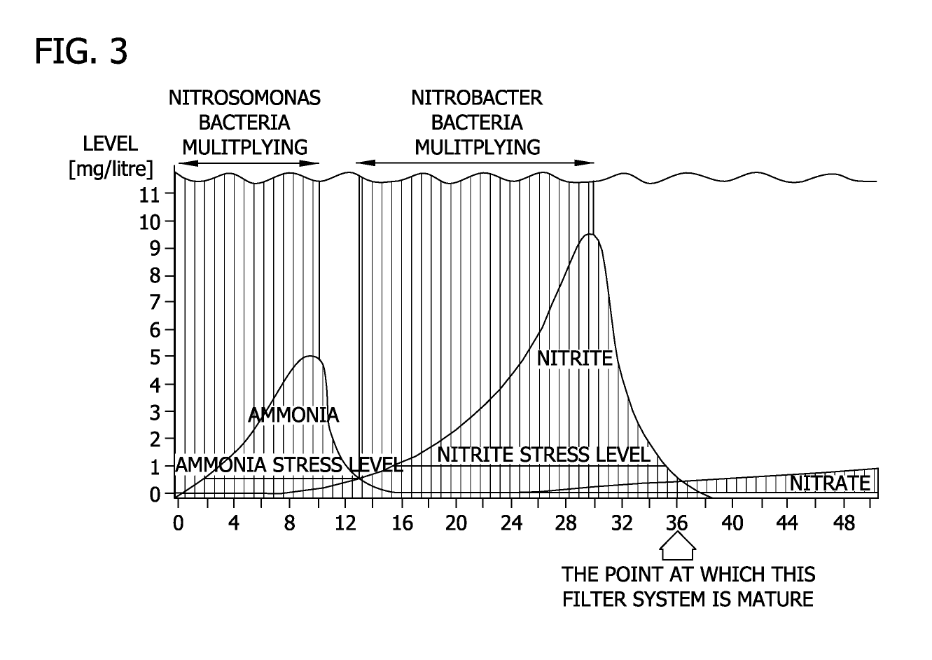

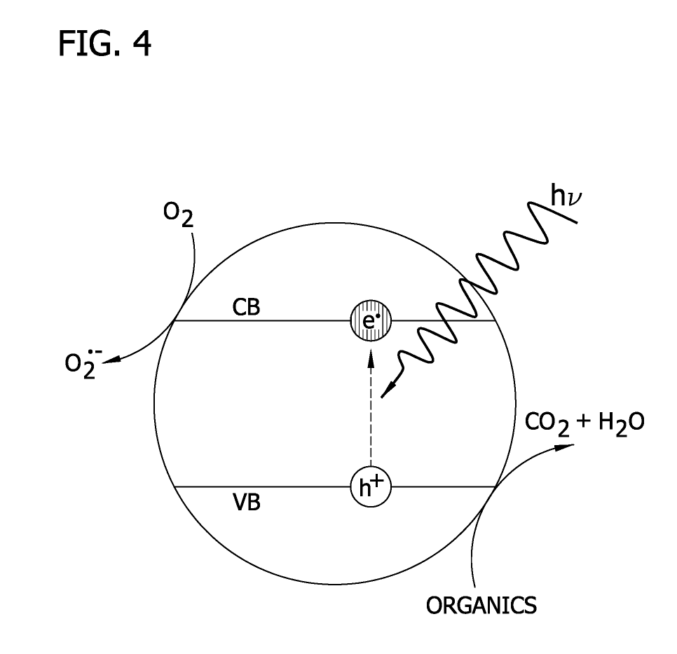

An exemplary configuration of the flow-through PECO device of the present invention is shown in FIG. 2. The cylindrical flow-through configuration includes a composite photoelectrocatalytic photoanode 10 and a corresponding cathode 14. The photoanode 10 and cathode 14 are house within a housing 16. The housing 16 includes a water inlet 12 and outlet 13. An electrical potential is applied across the cathode 14, composite photoanode 10 by an electrical power source and potentiostat 18. A reference electrode 20 is in electrical communication with the potentiostat 18. A UV light source 22 illuminates the composite photoanode 10. In the instant device, the TiO₂ catalyst layer of the composite photoanode 10 strongly adheres to the Ti electrode and does not disperse into the solution. So, no need exists for a module to separate the catalyst from the treated solution and/or to return the catalyst to the contaminated water. In addition, because the hydroxyl radical as well as Cl₂ are general oxidizing agents, other contaminants (besides ammonia) are oxidized. The instant PECO device is capable of completely degrading contaminants in a single pass. Water flow rate is also an important design parameter.

In an exemplary embodiment, the potential on the composite photoanode 10 is held constant relative to a saturated calomel reference electrode by the potentiostat 18, such as that available from EG&G, Model 6310. The potentiostat 18 is connected to the reference electrode through a semi-micro saline bridge, such as available from EG&G, Model K0065. The saline bridge may be disposed inside the reactor close to the composite photoanode 10. The current passing through the PECO device may be measured.

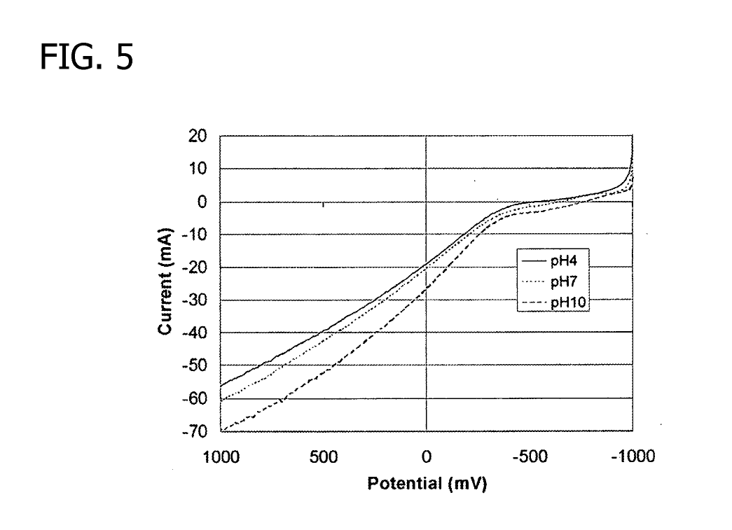

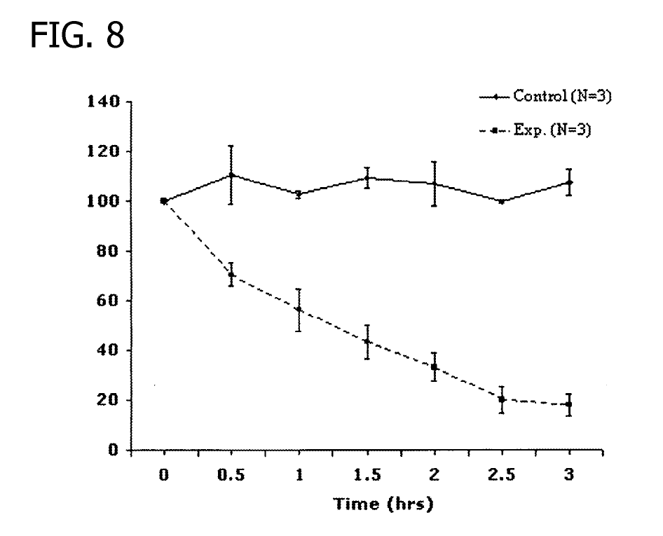

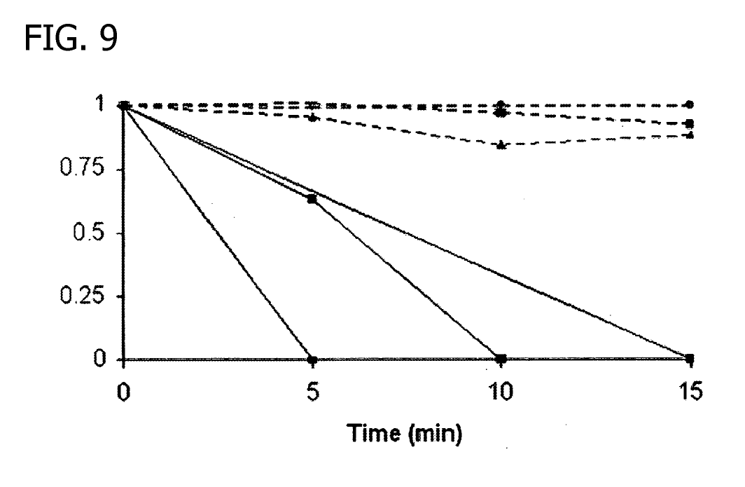

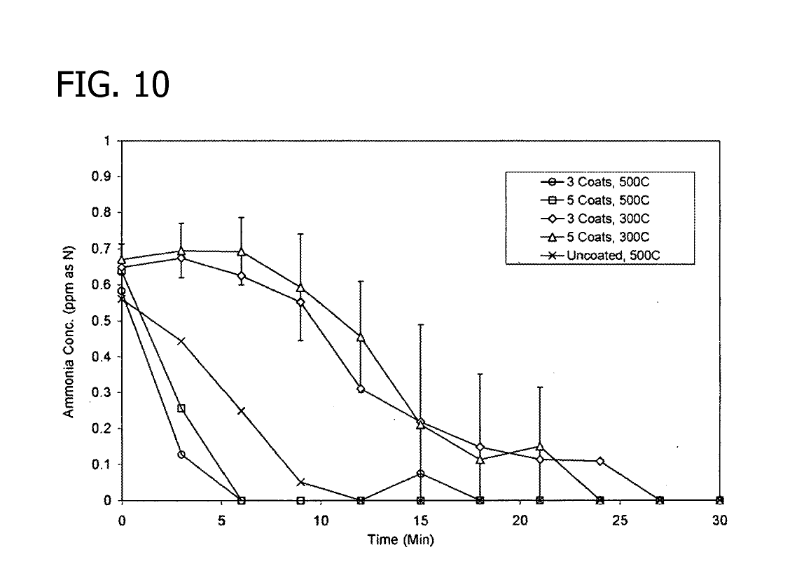

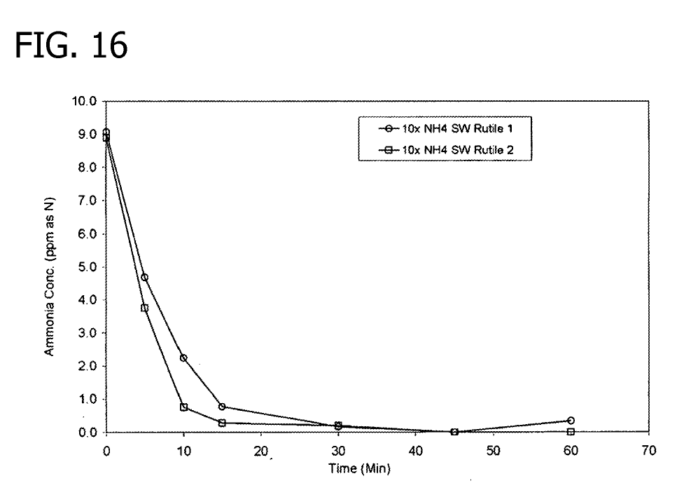

The EG&G potentiostat was used to obtain data shown in FIGS. 5-9. Data shown in FIGS. 10-22 were obtained using a Princeton Applied Research Model VMP2/Z-01 Electrochemical Analyzer. The saline bridge was used with the EG&G system. A silver wire reference electrode was also used.

The instant potentiostat is a variable current source that can measure a voltage between two electrodes. The potentiostat can perform a wide variety of electrochemical functions, but the two exemplary functional modes are constant current and constant voltage. In constant current mode, the potentiostat supplies a user specified current to the electrodes. In constant voltage mode, it supplies current to the electrodes while monitoring the voltage. It can then continually adjust the current such that the voltage will remain constant at a user specified value. A potentiostat can also be configured to supply pulses.

During operation of the instant PECO device, ammonia steadily disappeared from the water as determined by the assay limits in approximately 2.5 hrs. Zero to trace amounts of nitrite and nitrate were present in the 3 hr samples, which indicates that ammonia was converted to nitrogen gas. The reaction was substantially faster in seawater (35 ppt INSTANT OCEAN), whereby ammonia completely disappeared at 1.5 hrs. The faster reaction kinetics in seawater may be due to break point chlorination because of the presence of chloride ions leading to photoelectrocatalytic oxidation production of Cl₂, HOCl, and Off oxidizing specie in the seawater. Faster kinetics may also be due to the freer flow of electrons in the saline water.

As shown in FIG. 5, at pH 4, pH 7 and pH 10, the photoanode generated an anodic current at applied potentials greater than −0.55 V. Thus, TiO₂ has a flat band potential less than zero. As the pH of the solution increased from 4 to 7 to 10, the potential that generated an anodic current changed from −0.55 V to −0.65 V to −0.76 V. This is an average change of 33 to 38 mV per pH unit rather than the expected 59 mV per pH unit, which may have been due to the electrolyte not fully equilibrating with the photoanode surface prior to the start of an experiment.

Any temperature of liquid water is suitable for use with the instant PECO device. Preferably, the water is sufficiently low in turbidity to permit sufficient UV light to illuminate the composite photoanode.

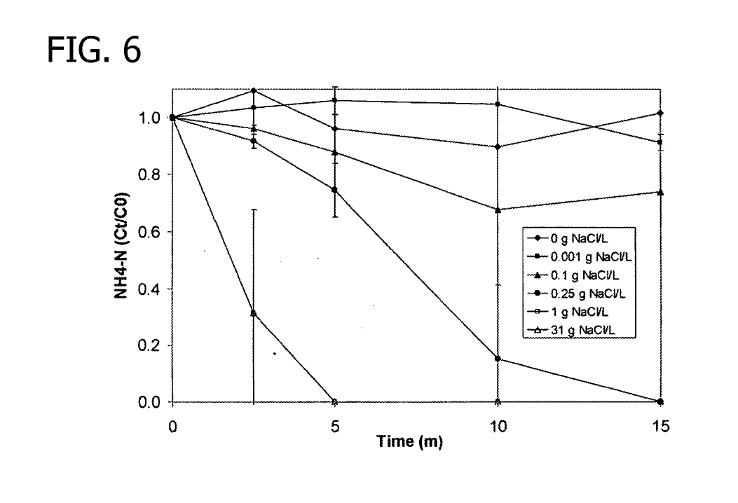

As shown in FIG. 6, in a NaCl electrolyte of 0 g/L, no ammonia was removed. The NaCl solution at 0.25 g/L showed total ammonia removal in 15 minutes. Ammonia in a NaCl solution of 1 g/L was completely removed in 5 minutes, and, ammonia was completely removed in 2.5 minutes when the NaCl concentration was increased to 31 g/L. 31 g NaCl/L is particularly useful for saltwater aquaculture systems, as this is the chloride equivalent found in natural seawater (i.e., Cl⁻ concentration ˜19 g/L). Thus, chloride concentration affects the ammonia removal rate. Since no ammonia removal was observed in the absence of chloride, ammonia may have been oxidized directly by the photoelectrochemical production of chlorine.

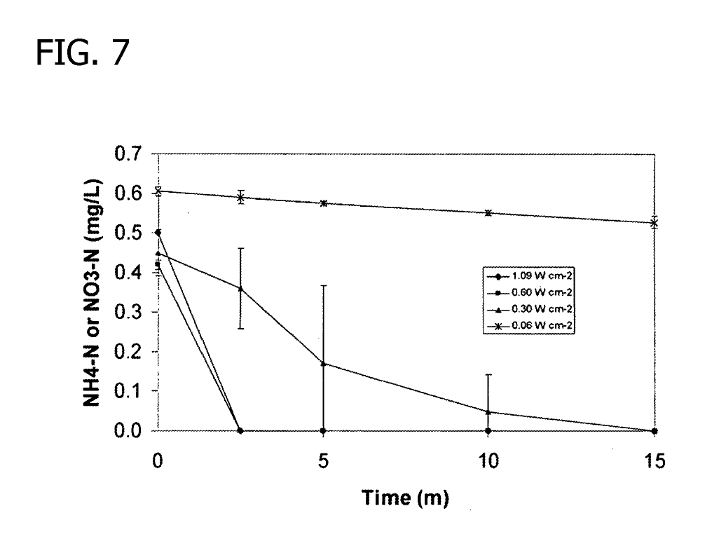

As shown in FIG. 7, four intensities of light were tested to compare NH₄⁺/NH₃ removal and resultant NO₃⁻ and NO₂⁻ production: 1.09, 0.60, 0.30, and 0.06 W/cm². Each level of intensity showed comparable distribution of wavelengths of light ranging from 200-900 nm. At 0.06 W/cm², 13% of initial ammonia was removed in fifteen minutes with no NO₃⁻ or NO₂⁻ produced. At 0.3 W/cm², total ammonia removal was observed in 15 minutes with 9% of the ammonia-nitrogen converted to NO₂⁻, and 4% converted to NO₃⁻. At 0.6 W/cm², total ammonia removal was observed in 15 minutes, with 3% of the ammonia-nitrogen converted to NO₂⁻, and 3% converted to NO₃⁻. At 1 W/cm², total ammonia removal was observed in 15 minutes, with 1% of the ammonia-nitrogen converted to NO₂⁻, and 13% converted to NO₃⁻. Ammonia removal and resultant nitrogen species depend on light intensity.

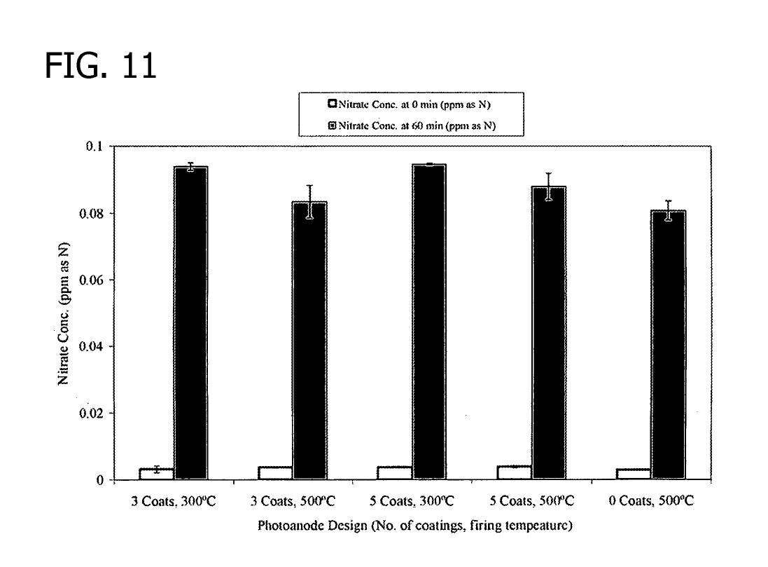

As shown in FIGS. 10 and 11, composite photoanodes prepared by sintering the TiO₂ film at 500° C. removed ammonia from water significantly faster than composite photoanodes fired at 300° C. Composite photoanodes prepared by applying three coatings of TiO₂ did not perform significantly better than photoanodes prepared by applying five coatings of TiO₂. As shown in FIG. 10, uncoated Ti foil supports fired at 500° C. demonstrated faster ammonia removal than coated Ti foil supports fired at 300° C. Similar reaction kinetics were observed for composite photoanodes coated with nanoparticulate TiO₂ and sintered at 500° C. suggesting that a thin, highly catalytic, nanoporous TiO₂ film forms on the surface of uncoated Ti when it is heated to 500° C. As shown in FIG. 11, no nitrite and very little nitrate (<16% of ammonia nitrogen was found as nitrate nitrogen) were formed during the incubations suggesting that the majority of the ammonia was oxidized into nitrogen gas.

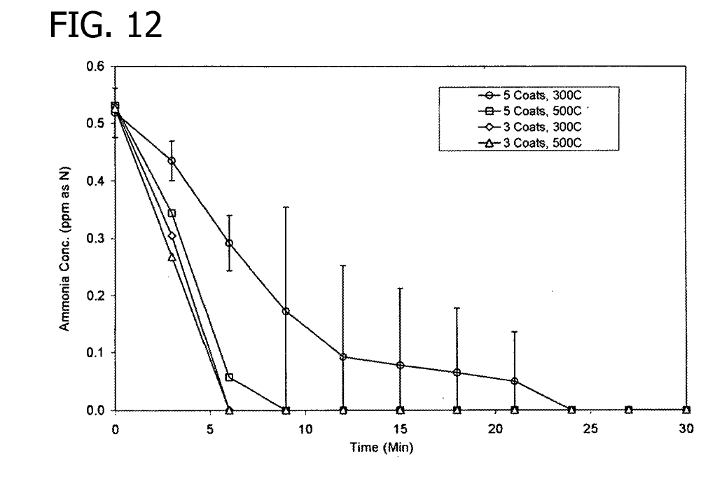

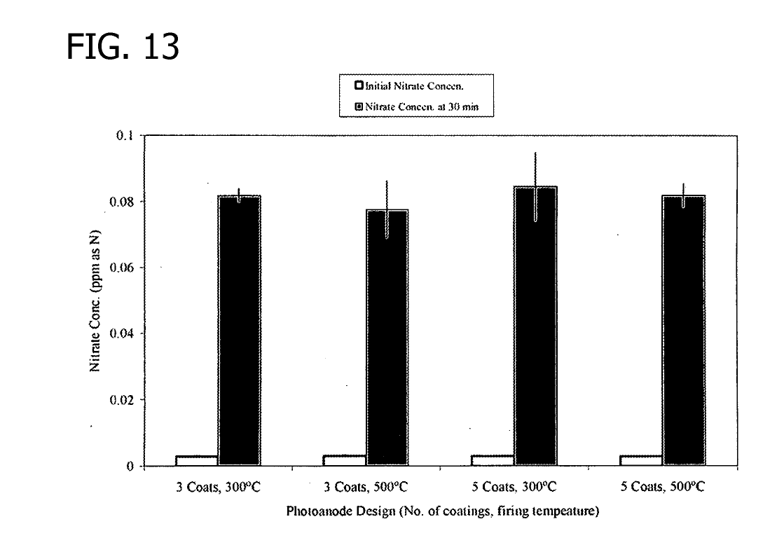

As shown in FIGS. 12 and 13, composite photoanodes having a Ti foil support and a thin-film of TiO₂ doped with Pt and sintered at 300° C. removed ammonia from solution slightly better than undoped TiO₂ coatings sintered at the same temperature. There was an insignificant difference in ammonia removal between undoped and Pt-doped TiO₂ coatings sintered at 500° C. There was also an insignificant difference between platinized and non-platinized photoanodes in terms of the amount of nitrate formed. Approximately 15% of the original nitrogen as ammonia was converted into nitrogen as nitrate on average. Thus, the data suggest that there is no advantage of using Pt-doped TiO₂ thin films over pure TiO₂ films for converting aqueous ammonia into nitrogen gas in the instant PECO device. The Pt may have functioned as an electron sink in the photocatalytic reactions, which may be unnecessary when a bias (voltage) is applied to the catalyst to pull off photogenerated electrons. Thus, the addition of Pt to the instant anodes would be an unnecessary additional expense in the instant PECO device.

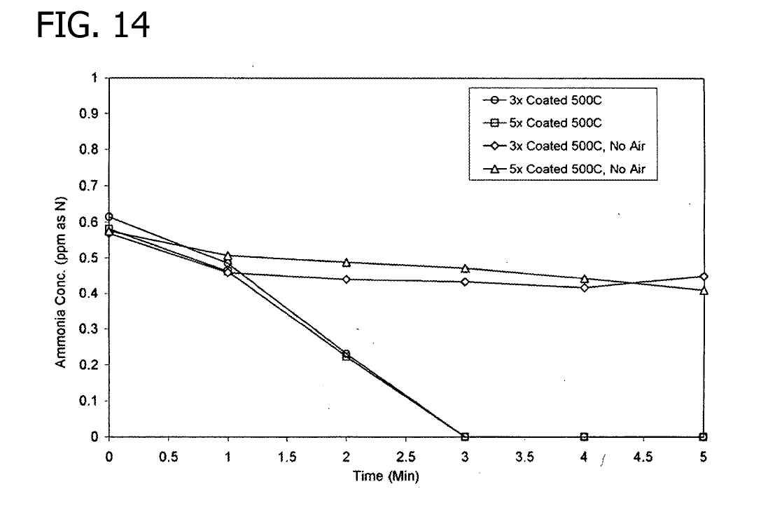

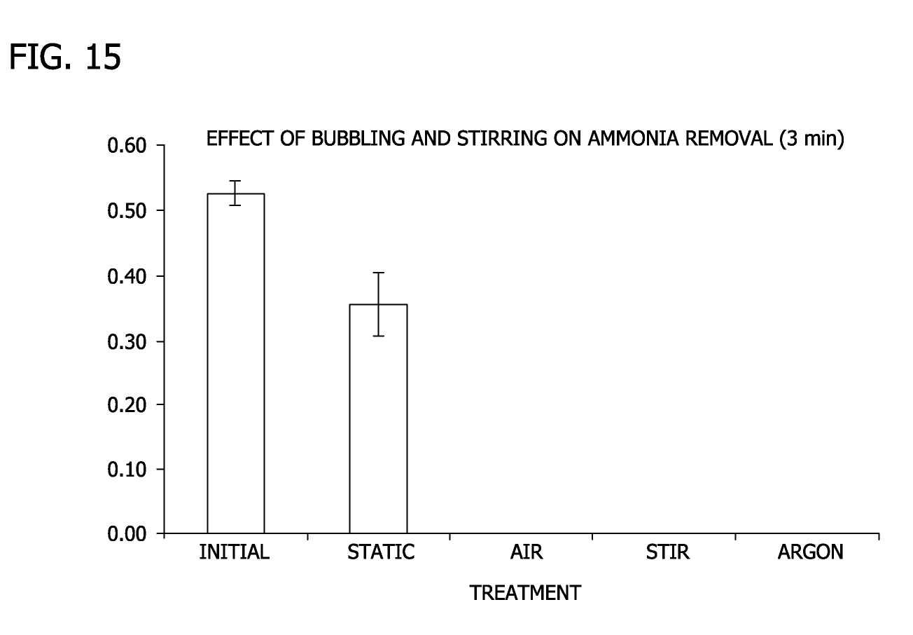

As shown in FIGS. 14 and 15, bubbling air into the static incubation test reactors was advantageous for rapid ammonia removal. An experiment was conducted to determine the mechanism of this aeration effect. Without being bound to any theory, it may be hypothesized as follows: (1) aeration disrupts a boundary layer that prevents ammonia from reaching the anode surface, and (2) aeration provides oxygen required for the reaction to occur, whereby oxygen is a likely final electron acceptor in the redox reactions occurring in the experiment.

There were four treatment groups: static control (no air, no stirring), water mixed with a magnetic stir bar, aeration with air, and, aeration with argon gas (no oxygen present in the system). The results show efficient ammonia removal with stirring, air aeration, and argon aeration indicating that such mixing facilitates the reaction supporting hypothesis 1. The result also suggests that ammonia removal in the instant PECO flow-through device would not be limited by the presence of boundary layers when there is sufficient flow, preferably turbulent flow, through the device.

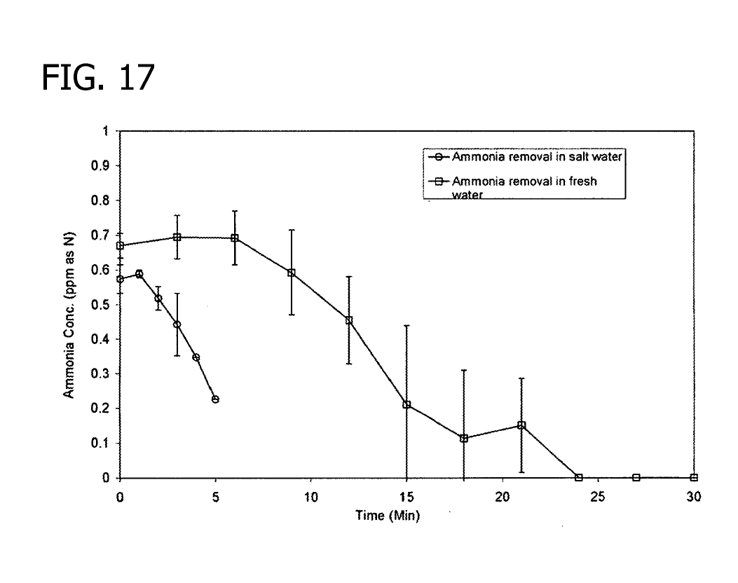

As shown in FIG. 17, ammonia removal was significantly faster in 100% seawater (40.5 g/L INSTANT OCEAN) compared to freshwater containing 1 g/L NaCl. The data also suggest that some chloride must be present in the water for the reaction to proceed. One possible explanation is that chloride ions are required for the silver reference electrode to form a silver/silver chloride half-cell maintaining a proper voltage between the anode and cathode. Another possible explanation is that (under photoelectrocatalytic oxidation) ammonia is not directly oxidized on the anode surface. Instead, ammonia may be oxidized by reactive hypochlorite generated in situ.

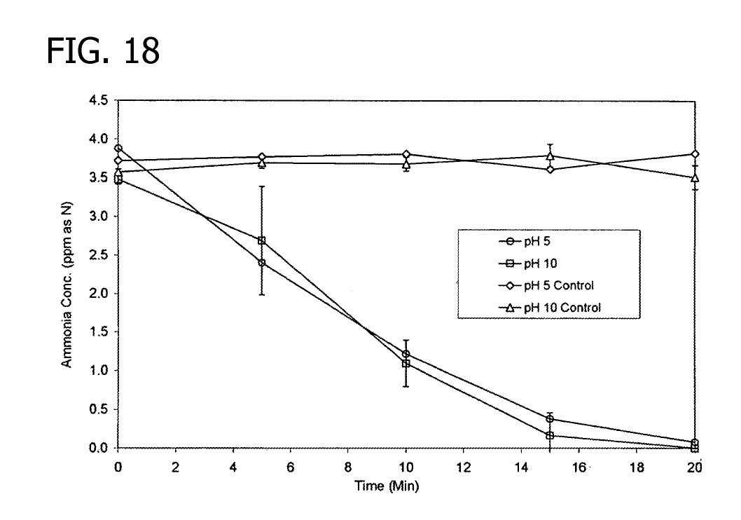

As shown in FIG. 18, ammonia removal rates were identical in water at pH 5 and pH 10 suggesting that oxidation of ammonia is independent of pH over the range of pH values useable in almost all aquaculture applications. The results also indicate that pH does not play a significant role in regulating the oxidation of aqueous ammonia. In aqueous solution, ammonia exists in equilibrium between the ionized (NH₄⁺) and the non-ionized form (NH₃) having equilibrium pKₐ 9.3. Therefore, approximately 85% of the ammonia was in the NH₃ form at pH 10, and essentially 100% in the NH₄⁺ form at pH 5. There was a possibility that the positively charged NH₄⁺ molecule might not have been oxidized as efficiently as the neutral NH₃ species because it would have been repelled by the positive bias on the photoanode surface, however, that did not occur. Ammonia oxidation may not have occurred directly upon the anode surface. Instead, ammonia may have been oxidized by a soluble reactive intermediary such as hypochlorite.

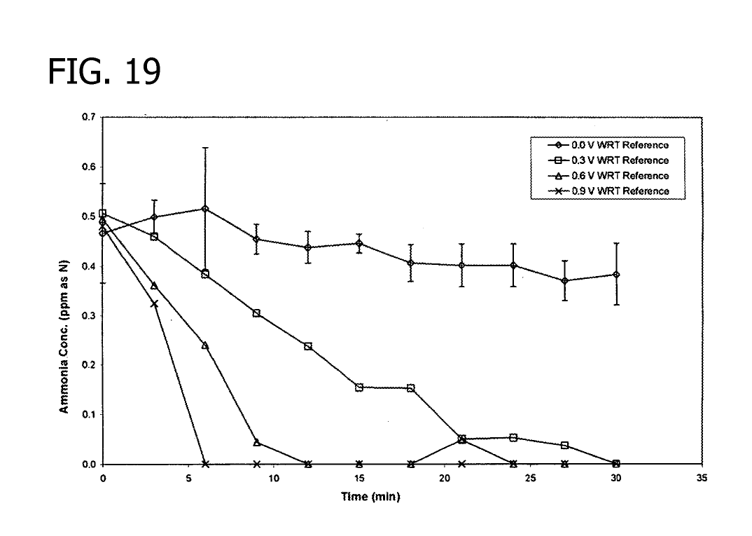

In other experiments, a potential of 1 V was shown to be highly effective. As shown in FIG. 19, four other applied voltages were tested being 0.0, 0.3, 0.6, and 0.9 V. Lower voltages may also be as effective as higher voltages. Commercial-scale devices are more cost-effective to operate at lower voltages. At voltages higher than ˜1.2 V DC between the anode and cathode, water electrolysis occurs, whereby water molecules break apart forming hydrogen gas (H₂) and oxygen gas (O₂). However, applied pulsed voltages greater than 1.2 V may be beneficial. Pulsing the applied voltage may minimize water electrolysis and increase ammonia oxidation efficiency.

No ammonia removal was observed without an applied bias. Ammonia removal was greater at higher voltages probably because more electrons were carried away maintaining a greater oxidative photoanode surface. Significant hydrogen gas production at the cathode was also observed indicating water electrolysis forming H₂ and O₂. Electrolysis of water occurs at voltages higher than 1.2 V, which was exceeded at all voltages tested because (with the Ag wire reference electrode) a voltage of 0 between the reference electrode and anode translates to a voltage of approximately 1.2 V between the anode and cathode. Pulsing of the applied voltage may minimize water electrolysis.

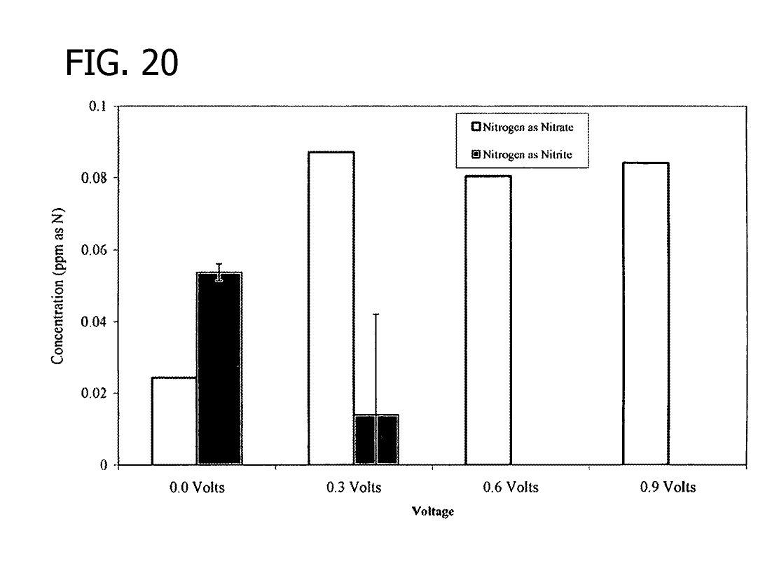

FIG. 20 shows the effect of applied voltage on nitrate removal. The results indicate that increasing the operating voltage increases the rate of formation of nitrate until a plateau is reached around 0.3 V. The instant PECO device minimizes the formation of nitrite suggesting that the applied voltage is preferably at least +0.6 V.

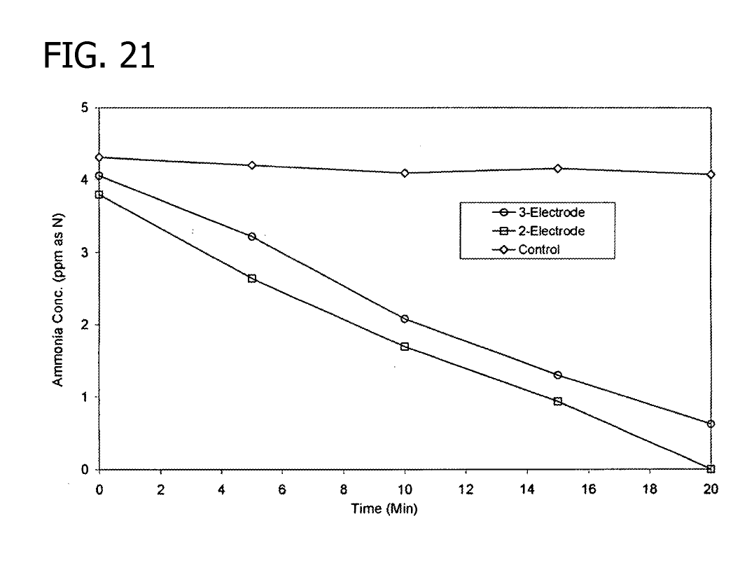

A 3-electrode system would be more expensive under aquaculture conditions. Efficacy of a 2-electrode configuration was tested. A 2-electrode PECO device was tested at 2.2 V applied between the photoanode and cathode, which corresponds to the same voltage between the anode and cathode in the 3-electrode configuration (i.e., 1.2 V half-cell +1 V). As shown in FIG. 21, ammonia removal rates were essentially the same for the 2- and 3-electrode units.

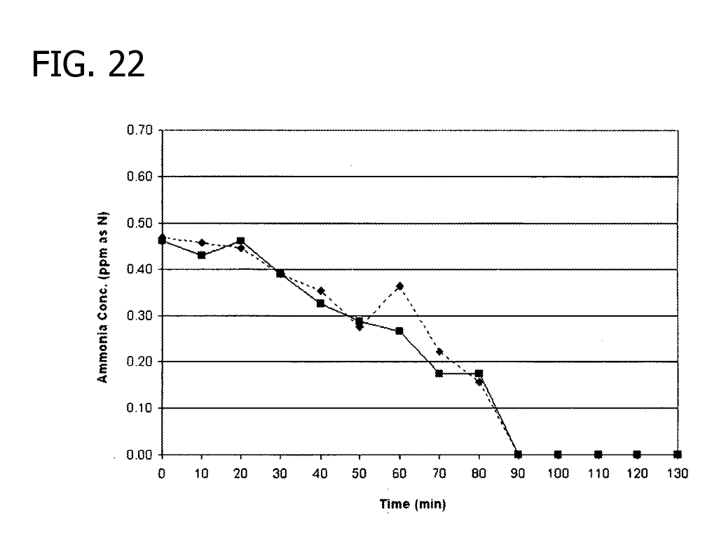

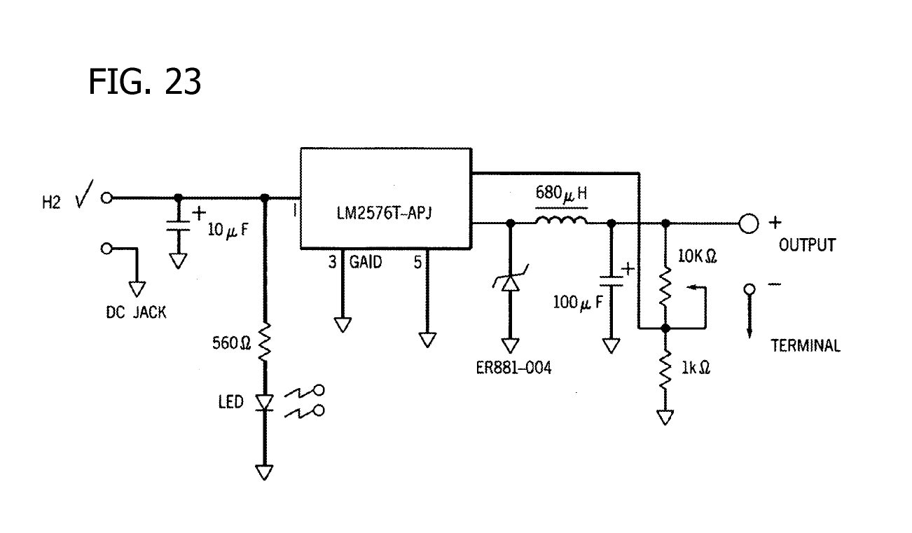

As shown in FIG. 22, there was complete ammonia removal from seawater initially spiked with ˜0.7 ppm ammonia-nitrogen in 90 minutes using the flow-through reactor rather than the static reactors employed for the earlier tests discussed above. Commercial applications on the instant invention may use flow-through reactors where variables such as water flow rates through the device (i.e., photocatalyst contact time) determines reaction efficiency.

The amount and type of dissolved ions can affect the photocatalytic reaction rate, which is important to consider in designing a PECO unit for treating ammonia in saltwater systems. The potential for generating chlorine in seawater is an operating concern for PECO. It is important to understand the effect of operating voltage on the chlorine generation rate as compared to the ammonia degradation rate in seawater systems. Thus, the voltage is to be optimized to minimize chlorine generation while providing a suitable ammonia conversion rate. If ammonia removal occurs by breakpoint chlorination as hypothesized (see reactions I-III above), an exemplary device would generate only enough chlorine to react with the ammonia being generated so that no chlorine would remain to be sent back to the tank. Such a system would require effective real-time sensors for both chlorine and ammonia. A conventional activated carbon filter may be employed to absorb and filter chlorine from the aquarium or aquaculture water.

Alkaline buffers, such as sodium and potassium bicarbonate, and sodium and potassium hydroxide, may be employed to stabilize pH without significantly interfering with efficient operation of the instant PECO device. Various processes occur during photocatalytic and photoelectrocatalytic oxidation that can affect the pH of the water being treated. Any changes in the pH during treatment can alter the reaction kinetics. So, for aquaculture applications, pH is monitored to protect fish health. The ΔpH is relatively small at low initial ammonia concentrations.

Other control conditions may also be optimized. For example, the lights may be active while the electrical potential is inactive, or the electrical potential may be active while the lights are inactive.

Various UV light sources, such as germicidal UVC wavelengths (peak at 254 nm) and black-light UVA wavelengths (UVA range of 300-400 nm), may also be employed. For the instant composite photoanodes, the optimal light wavelength for driving photoelectrocatalytic oxidization is 305 nm. However, various near-UV wavelengths are also highly effective. Both types of lamps emit radiation at wavelengths that activate photoelectrocatalysis. The germicidal UV and black light lamps are widely available and may be used in commercial applications of the instant PECO device.

The intensity (i.e., irradiance) of UV light at the photoanode may be measured using a photometer available from International Light Inc., Model IL 1400A, Super-Slim probe. An exemplary irradiation is greater than 3 m Wcm².

UV lamps also have a “burn-in” period. UV lamps have a limited life in the range of approximately 6,000 to 10,000 hours. UV lamps also typically lose 10 to 40% of their initial lamp irradiance over the lifetime of the lamp. Thus, it is important to consider the effectiveness of new and old UV lamps having >5,000 hrs burn-in period lamps in designing and maintaining oxidation of ammonia.

### Methods of Environmental Remediation

Another aspect of the present disclosure is directed to methods of environmental remediation. “Environmental remediation” is used according to its ordinary meaning to refer to the removal of contaminants from environmental media such as, for example, soil, groundwater, sediment, and surface water for the general protection of human health and the environment. The methods include providing a sample of an environmental medium including contaminants and exposing the sample of an environmental medium to photoelectrocatalytic oxidization as described above.

The disclosure will be more fully understood upon consideration of the following non-limiting Examples.

### Example 1

Static test system. The photoanode was rolled into the cylinder and disposed into a 300 ml glass beaker. The UV light source contained in a quartz sleeve (32 mm ID, 35 mm OD, 15 cm long) was disposed in the center of the beaker. The cathode (which was the counter electrode) comprised a Ti wire (0.5 mm diameter and 15 cm long from Goodfellow Corp., Oakdale, Pa.). The reference electrode comprised a silver wire (0.5 mm diameter and 15 cm long from Goodfellow Corp., Oakdale, Pa.).

The cathode and reference electrodes were attached to the outer wall of the quartz sleeve with silicon glue running parallel and separated by 2 cm. The light source was a 9-watt, low-pressure mercury vapor lamp (Jebo Corp., Taiwan, China) that emitted ultraviolet germicidal irradiation (UVGI) at a primary wavelength of 254 nm. The distance from the light to the photoanode was approximately 5 cm. Four identical static PECO systems were prepared for replicate testing.

Each experiment, except the 2-electrode experiment, were performed using a 3-electrode configuration being a photoanode, a cathode, and a reference electrode. In 3-electrode configuration, a potentiostat controlled the voltage applied to the photoanode with respect to a reference electrode. A silver wire was used as the reference electrode, which functioned as a Ag/AgCl half cell in water containing chloride ions. Where relevant, voltages are reported with respect to the silver wire reference. In the 3-electrode configuration, the actual voltage between the photoanode and the cathode 1.2 V higher than the reported voltage.

Experiment procedure. The beakers were filled with 250 ml of either 100% seawater (made using 40.5 g/L of INSTANT OCEAN from Spectrum Brands, Inc., Madison, Wis.) or freshwater containing 1 g/L NaCl. Each water was spiked with ammonium chloride to provide the ammonia source (0.5 to ˜10 mg/L initial concentration). The wetted area of each photoanode was approximately 180 cm². In several experiments, air was bubbled into each beaker providing aeration and assuring uniform mixing of the water during the experiments using a small aquarium diaphragm air pump. Each experiment was conducted at room temperature (22°±2° C.).

The electrodes were connected to a Model VMP2 multi-channel potentiostat from Princeton Applied Research, Oak Ridge, Tenn. During operation, a constant voltage was applied between the photoanode (the working electrode) and the reference electrode. The potentiostat was controlled (and the data on voltage and current were recorded) using EC-Lab V.92 software from Princeton Applied Research, Oak Ridge, Tenn. Experiments were started by simultaneously turning on both the UV lights and applied voltage

At set intervals every 2-5 minutes, 1-ml samples of water were collected from each beaker and the ammonia concentrations were measured. Samples were collected in 1.5 ml microcentrifuge tubes and measured within 1 hr or stored at 4° C. for later measurement. No change was observed in ammonia or nitrate concentrations for up to one week of storage.

Larger samples (˜10 ml) were collected at the end of each experiment to measure nitrite and nitrate concentrations. These samples were stored at 4° C. for later measurement. Experiments lasted several minutes or 1-4 hr. 100% ammonia removal and duration depended upon the experimental conditions being evaluated. Ammonia removal required both UV light and applied voltage. Controlled incubations also included devices having light and no applied voltage.

Ammonia concentrations were measured using the indophenol method (Tetra kits) modified for use with a microtitre plate spectrophotometer. Ammonia test reagents were obtained from Tetra of Blacksburg, W. Va. Nitrite and nitrate concentrations were measured using ion chromatography from Dionex of Sunnyvale, Calif.

Flow-through PECO test device. A flow-through PECO device was fabricated by modifying a commercially available 9-watt UV sterilizer from Jebo Corp., Taiwan, China. Regarding the device components for the static system, a titanium wire was spot-welded to the back of the photoanode providing an electrical connection. The device was connected to a 7-liter aquarium and water was pumped through the system with an aquarium power head at constant flow rate of 2 gallons per hour. As with the static experiments, water samples were collected at regular intervals and ammonia concentrations were measured calorimetrically.

### Example 2

Chemicals. TiO₂ coatings on photoanodes were made from titanium isopropoxide (Aldrich Chemical, 97%) and nitric acid (Aldrich Chemical, American Chemical Society reagent grade). NH₄Cl and NaCl were obtained from Fisher Scientific (Fairlawn, N.J.). NaNO₃ and NaNO₂ standards were obtained from SPEX Certiprep (Metuchen, N.J.). NH₄⁺/NH₃ was measured using commercial kit reagents for indophenol method. All chemicals were used without further purification. All solutions were prepared with ultrapure water (18.1 MS2 cm) from a NANOpure UV system (model 07331, Bamstead/Thermolyne, Dubuque, Iowa).

Composite Photoanode Preparation. The photoanode substrate material was annealed titanium foil 0.05 mm thick (99.6+% purity, Goodfellow Cambridge Ltd). Foils were cut to size for the experimental cell and pre-heated to remove organic contaminants by firing for 300° C. for 3 h. Suspensions of titanium dioxide were prepared using processing methods. (See Candal et al., 1998). Photoanodes were dip-coated into the TiO₂ suspension to achieve homogenous coatings of TiO₂ on titanium metal support. Two additional dip-coatings were applied, and the resulting materials were fired at 400° C. for 3 h to sinter the TiO₂ coating to the Ti support.

Experimental Setup. The reaction vessel was a rectangular Teflon block measuring 15.6 cm high and 7.8×8 cm, and having a single cylindrical cavity measuring 5.1 cm in diameter providing a single-compartment cell. A 4.3 cm diameter hole was cut through one side of the cell and covered with a quartz window. Light was passed through the window to irradiate the photoanode. Light was generated by a 500 W Oriel brand Hg(Xe) lamp (Lamp Housing Model No. 66021, Power Supply Model 8540, Lamp Model No. 66142, Newport Stratford, Conn.). Light was measured with an International Light IL 1700 research photometer with a SED033/QNDS2W/detector. Distribution of wavelengths (200-900 nm) was measured by an Ocean Optics USB2000™ probe and 001 Base31™ software, version 2.0.1.4.

To prevent heating of the electrolyte, infrared radiation was absorbed by a water filter. Electrolyte was mixed by a stir bar and magnetic stir plate. Compressed air was slowly bubbled into solution. There was no observed loss of electrolyte volume during the fifteen experiments. The cell was left unsealed and exposed to room air. Each experiment employed a saturated calomel electrode (SCE) with a VYCOR frit and a bridge tube filled with 3M KCl filling solution (Princeton Applied Research-Ametek, Oak Ridge, Tenn.).

Ammonia solution was freshly prepared before each experiment. The pH of the solution was adjusted with 0.1M NaOH and/or 0.1M H₂SO₄. During each experiment, 1.3 mL samples were periodically withdrawn for NH₄⁺/NH₃ measurement. For the determination of NO₂⁻ and NO₃⁻, 1.3 mL samples were taken at the start and end of every experiment. With the exception of the flow-through experiments, all samples were taken from the solution in the cell, from the irradiated side of the photoanode, and drawn from the top of the solution using a 1-5 mL pipette with disposable pipette tips. For experiments using the flow-through set-up, samples were taken from the 4 L reservoir. All samples were stored at 4° C. until analyzed. To control the potential during these studies, and to measure the photocurrent generated, an electrochemical impedance analyzer was used (Princeton Applied Research-Ametek, Oak Ridge, Tenn.) along with PERKINELMER Model 250 Research Electrochemistry Software (PerkinElmer, Waltham, Mass.).

Analytical Methods. The pH was measured using pH electrode (model 8272BN; Thermo Orion, Beverly, Mass.) and model 370 Thermo Orion pH meter (Thermo Orion, Beverly, Mass.). Ammonia was measured by the phenate method (APHA-AWWA-WPCE, 1985), using a spectrophotometer (λ=600 nm) with a 96-well microplate autoreader (model EL311, BioTek Instruments, Winooski, Vt.). Results were analyzed with DeltaSoft3 version 2.26 software (Hillsborough, N.J.).

NO₃⁻ and NO₂⁻ concentrations were measured using a Dionex ion chromatograph (IC) with an Ion Pac AG9-HC guard column (4×50 mm), and an Ion Pac AS9-HC analytical column (4×250 mm) connected to an ED 50 conductivity detector. An AS 40 autosampler and GP 50 gradient pump were also used, with a sample loop volume of 200 μL.

NO₃⁻ and NO₂⁻ levels were calculated using a five-point calibration curve. NH₄⁺/NH₃ was measured using a six-point calibration curve. Both measurements used external standards, with a blank sample and/or internal standard re-checked every 20 samples. Samples were run in duplicate with duplicates differing from one another less than 5%.

For all concentrations of NaCl tested, less than 4% of the ammonia was converted to NO₂⁻. (See Table 1). NO₃⁻ formation depended on NaCl concentration, whereby the following relationship between NaCl concentration and percentage of NO₃⁻ formed was observed: NaCl at 0 g/L→5% NO₃⁻ formed; NaCl at 0.001 g/L→1% NO₃⁻ formed; NaCl at 0.1 g/L→26% NO₃⁻ formed; NaCl at 0.25 g/L→41% NO₃⁻ formed; NaCl at 1 g/L→40% NO₃⁻ formed; and, NaCl at 31 g/L→13% NO₃⁻ formed. (See Table 1).

Table 1. Ammonia-nitrogen removal and product yields at different chloride concentrations: 0, 0.001, 0.1, 0.25, 1, and 31 g NaCl/L. Initial concentration NH₄⁺ 0.54 mg/L; initial pH 7; reaction time 15 mins; applied potential +1.0 V vs SCE, TiO₂-coated Ti photoanode irradiated with full spectrum light intensity 1.09 W/cm².

TABLE 1

| | % NH₄⁺ | % NO₂⁻ | % NO₃⁻ | % mass |
|---|---|---|---|---|
| NaCl (g/L) | remaining | yield^{a} | yield^{b} | recovery^{c} |
| 0 | 102 | 4 | 5 | 111 |
| 0.001 | 91 | BDL^{d} | 1 | 92 |
| 0.1 | 74 | BDL^{d} | 26 | 100 |
| 0.25 | BDL^{d} | 3 | 41 | 44 |
| 1 | BDL^{d} | 3 | 40 | 43 |
| 31 | BDL^{d} | BDL^{d} | 3 | 13 |

^{a}[NO₂⁻]^{t}/[NH₃]T, 0 × 100.
^{b}[NO₃⁻]^{t}/[NH₃]T, 0 × 100.
^{c}([NO₂⁻]ₜ₁₅ + [NO₃⁻]ₜ₁₅ + [NH₄⁺]ₜ₁₅)/[NH₄⁺]ₜ₀ × 100.
^{d}Below detection limits.

Table 2. Ammonia removal and product yields at different light intensities: 1.09, 0.60, 0.30, and 0.06 W/cm². Initial concentration NH₄⁺ 0.54 mg/L; initial pH 7; reaction time 15 mins; applied potential +1.0 V vs SCE, TiO₂-coated Ti photoanode irradiated with full spectrum light.

TABLE 2

| Light Intensity | % NH₄⁺ | % NO₂⁻ | % NO₃⁻ | % mass |
|---|---|---|---|---|
| (W/cm²) | remaining | yield^{a} | yield^{b} | recovery^{c} |
| 0.064 | 87 | BDL^{d} | BDL^{d} | 87 |
| 0.3 | BDL^{d} | 9 | 4 | 13 |
| 0.6 | BDL^{d} | 3 | 3 | 6 |
| 1 | BDL^{d} | 1 | 13 | 14 |

^{a}[NO₂⁻]^{t}/[NH₃]T, 0 × 100.
^{b}[NO₃⁻]^{t}/[NH₃]T, 0 × 100.
^{c}([NO₂⁻]ₜ₁₅ + [NO₃⁻]ₜ₁₅ + [NH₄⁺]ₜ₁₅)/[NH₄⁺]ₜ₀ × 100.
^{d}Below detection limits.

### Example 3

Fifteen minute chronoamperometry experiments were conducted to analyze the effects of salinity, light intensity, and applied potential on the photoelectrocatalytic oxidation of aqueous NH₄⁺/NH₃. TiO₂ coatings were applied to Ti foil by dip coating and sintered at 400° C. to sinter a nanoporous photocatalytic surface. Photoanodes were used in combination with a platinum wire counter electrode and saturated calomel reference electrode (SCE) to test ammonia removal and nitrate/nitrite production at initial ammonium/ammonia concentration 0.54 mg NH₄⁺/L, initial pH 7 in a well-mixed static reactor with compressed air sparged into solution. At applied potentials greater than −0.4 V, NH₄⁺ was totally removed in ten minutes and less than 3% of the initial NH₄⁺ was converted to NO₃⁻ and none was converted to NO₂⁻.

Chloride ions are present at 0.25 g NaCl/L or greater so that ammonia oxidation occurs. Conversion of NH₄⁺ and NO₃ to N₂ reached 40-41% at lower salinities, but at 31 g NaCl/L, only 3% of NH₄⁺—N was converted to NO₃⁻N. No more than 4% of NH₄⁺—N was converted to NO₂—N for any salinity tested. At least 0.3 W/cm² is applied for NH₄⁺ oxidation, and 9% or less of the initial NH₄⁺—N formed NO₃⁻—N or NO₂—N.

### Example 4

In this Example, the removal of bisphenol-A using the methods described herein was analyzed over time. Water samples including 100 μg/L bisphenol A, 20 ppt NaCl, and Milli-Q water (4 L total volume) were collected for analysis in vials containing 100 μl H₂SO₄ and 100 μl sodium thiosulfate (300 mg/L). H₂SO₄ serves as a preservative and sodium thiosulfate neutralizes residual oxidants in the sample to prevent continued oxidation in the sample vial.

Samples were treated using a 9-watt photoelectrocatalytic oxidation device (PECO) as described herein. Control samples were treated by (1) UV light and no applied potential (data shown); (2) no UV light and no applied potential; and (3) no UV light with applied potential. Water flow rate was 3.5 L/min. Levels of bisphenol-A was measured using liquid chromatography/mass spectrometry (LC/MS). The DPD (N,N-diethyl-p-phenylenediamine) method was used for measuring chlorine.

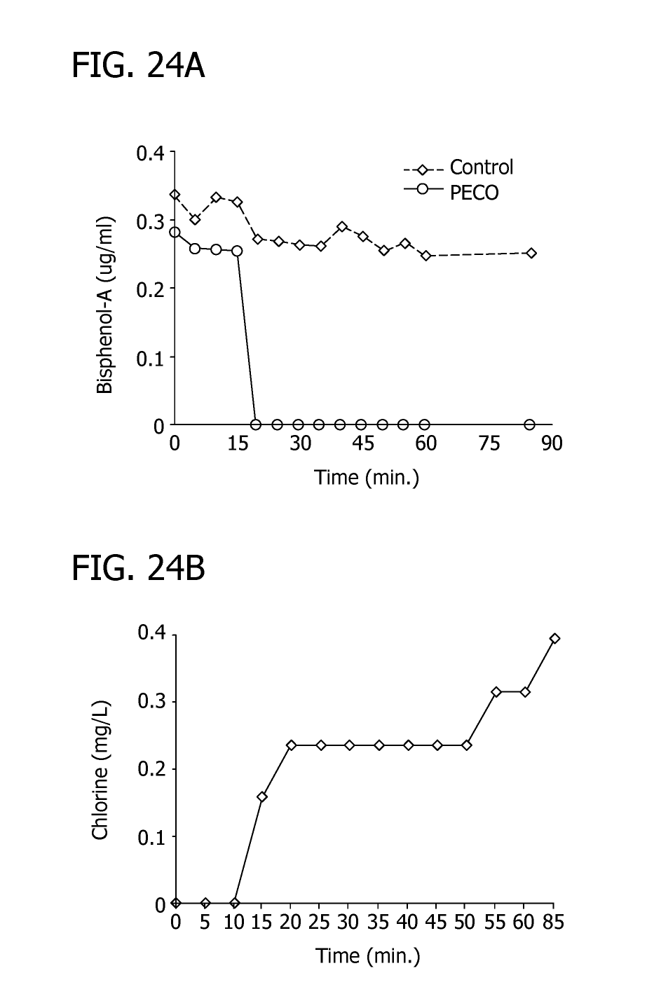

Bisphenol-A was reduced to undetectable levels. FIG. 24A shows the reduction of bisphenol-A and FIG. 24B shows the concentration of chlorine over time. Table 3 summarizes results.

TABLE 3

| Time | | | Chlorine | Current |
|---|---|---|---|---|
| (min.) | Control | PECO | (mg/L) | (mA) |
| 0 | 0.253 | 0.212 | 0.0 | 20 |
| 5 | 0.226 | 0.194 | 0.0 | 29 |
| 10 | 0.251 | 0.193 | 0.0 | 20 |
| 15 | 0.246 | 0.192 | 0.2 | 19 |
| 20 | 0.205 | 0 | 0.3 | 18 |
| 25 | 0.203 | 0 | 0.3 | 18 |
| 30 | 0.199 | 0 | 0.3 | 18 |
| 35 | 0.198 | 0 | 0.3 | 18 |
| 40 | 0.22 | 0 | 0.3 | 18 |
| 45 | 0.209 | 0 | 0.3 | 19 |
| 50 | 0.194 | 0 | 0.3 | 19 |
| 55 | 0.202 | 0 | 0.4 | 19 |
| 60 | 0.189 | 0 | 0.4 | 19 |
| 85 | 0.193 | 0 | 0.5 | 19 |

### Example 5

In this Example, the inactivation of Escherichia coli (E. coli) and MS2 coliphage using the methods described herein was analyzed over time. For E. coli inactivation, a recirculation batch system using a 36-watt PECO device, a 10 L glass aquarium filled with 5 L of de-chlorinated (100 mg/L chloride concentration) tap water, and a small aquarium pump was spiked with E. coli (ATCC 11775) at a concentration of ˜3×10⁸ cells/ml. The PECO device was activated and water samples were collected every 10 minutes for one hour. Results were obtained by enumerating on R2A agar and incubating for 24 hours at 37° C. Free chlorine was measured using a DPD colorimetric assay according to Standard Methods 4500. For the inactivation of MS2 coliphage, a recirculation batch system using a 36-watt PECO device, a 7-L glass aquarium filled with 4 L of ultrapure water containing 165 mg/L of NaCl (100 mg/L of chloride) was spiked with MS2 coliphage (ATCC 15597-B1). MS2 spike preparations were made according to Long and Sobsey (2004). Enumeration results were plotted as log inactivation versus time, where log inactivation is defined as the base 10 log of the final microbial concentration divided by the initial concentration.

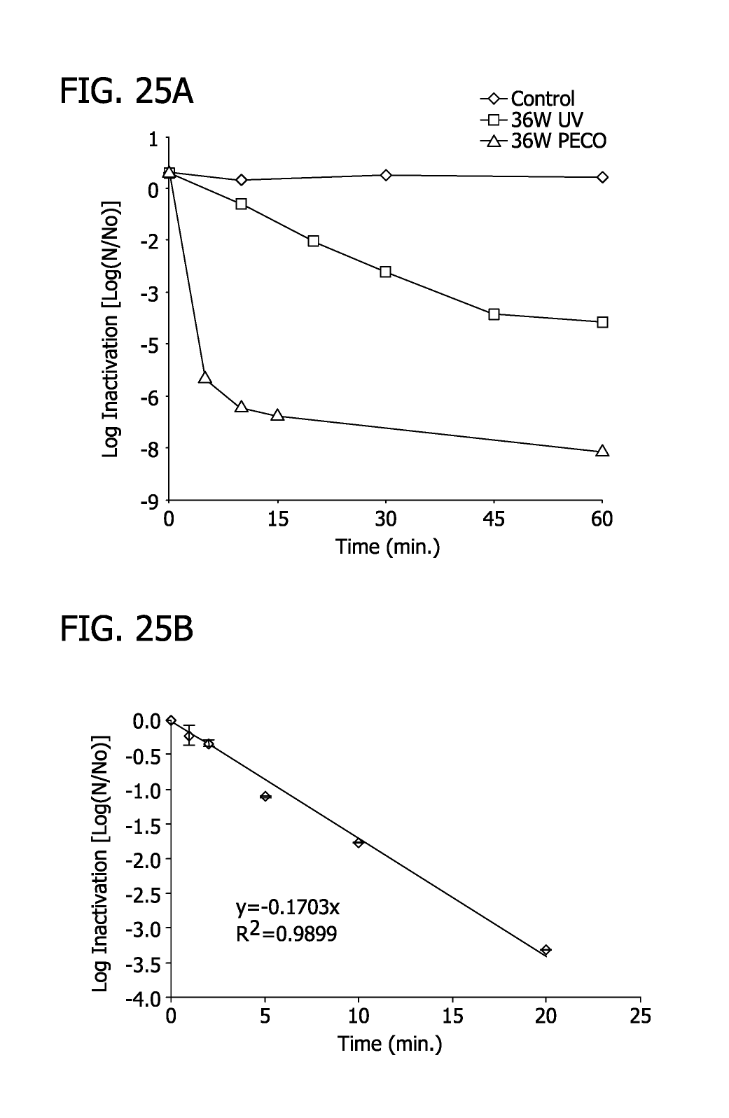

As shown in FIG. 25A, levels of E. coli in samples treated using photoelectrocatalytic oxidation decreased by over 6 log (99.9999%) in less than 10 minutes, whereas levels of E. coli in the sample treated with the 36-watt UV sterilizer decreased to a level of approximately 4 log over 1 hour. Levels in control (no PECO, no UV) remained constant. Chlorine production rate increased by 68% with an increase in flow velocity from 6 to 18 m/min. Chlorine production rate increased by 63% with an increase in space-time from 2.4 to 7.3 mg*min/mol.

As shown in FIG. 25B, 1-log inactivation of MS2 coliphage occurred after 5.2 minutes, 2-log inactivation occurred after 10.4 minutes, and 3-log inactivation occurred after 15.5 minutes. The maximum detectable inactivation was 6.7-log inactivation.

### Example 6

In this Example, the removal of various organic chemicals from an aqueous solution using the methods described herein was analyzed over time. Specifically, benzene, toluene, ethylbenzene, and xylenes (BTEX) using a 36-watt photoelectrocatalytic oxidation device (PECO) was analyzed. Samples were prepared using 1.2 L of tap water spiked gasoline. Samples were collected at time intervals following PECO and concentrations of BTEX chemicals were analyzed by GC/MS. Control samples were treated by (1) UV light and no applied potential; (2) no UV light and no applied potential; and (3) no UV light with applied potential.

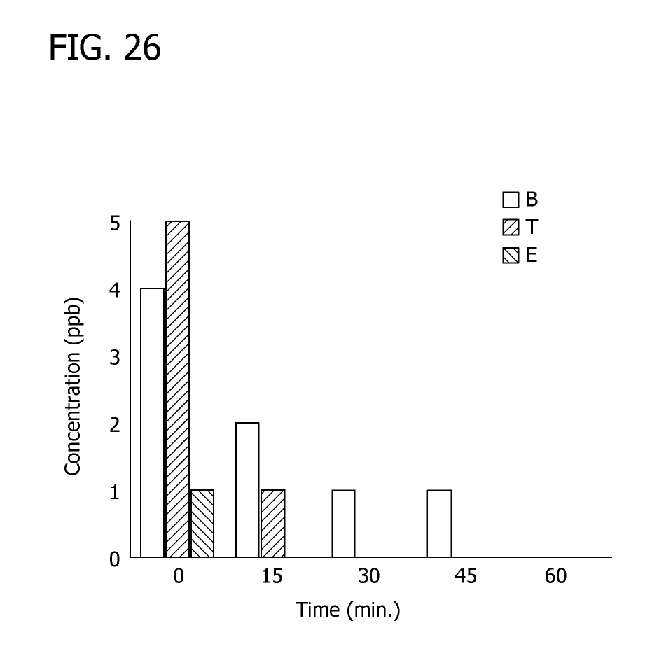

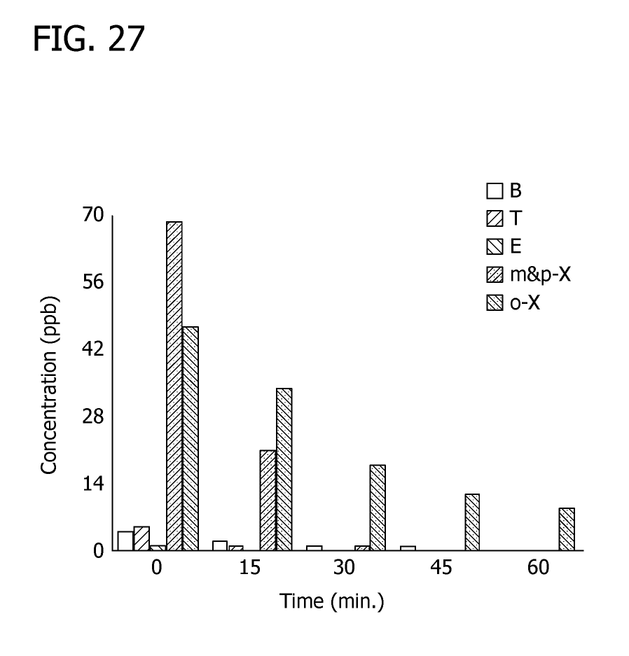

As shown in FIG. 26 and FIG. 27, benzene, toluene, ethylbenzene, and m- and p-xylenes were reduced to undetectable levels. o-Xylene concentration was also reduced over time. Table 4 summarizes the results of the experiment including m-, p-, and o-xylenes.

TABLE 4

| | | | | m- and p- | |
|---|---|---|---|---|---|
| Time | Benzene | Toluene | Ethylbenzene | Xylenes | o-Xylene |
| (min.) | (ppb) | (ppb) | (ppb) | (ppb) | (ppb) |
| 0 | 4 | 5 | 1 | 69 | 47 |
| 15 | 2 | 1 | 0 | 21 | 34 |
| 30 | 1 | 0 | 0 | 1 | 18 |
| 45 | 1 | 0 | 0 | 0 | 12 |
| 60 | 0 | 0 | 0 | 0 | 9 |

### Example 7

In this Example, the removal of gasoline constituents using the methods described herein was analyzed over time. Specifically, MTBE, THF, acetone, toluene, EB, oxylene, and 1,3,5-TMB were treated using the 36 Watt PECO device of Example 6. Lake water (i.e., a complex water matrix) was mixed with regular grade gasoline to form a surrogate contaminated groundwater sample. The sample was then stored for approximately one month prior to treatment. Twenty five gallons of the sample was treated by four (4) 36-watt PECO units connected in series in recirculation batch mode at a flow rate of 18 gpm. Samples were collected at regular intervals and concentrations of volatile organic compounds were analyzed by GC/MS.

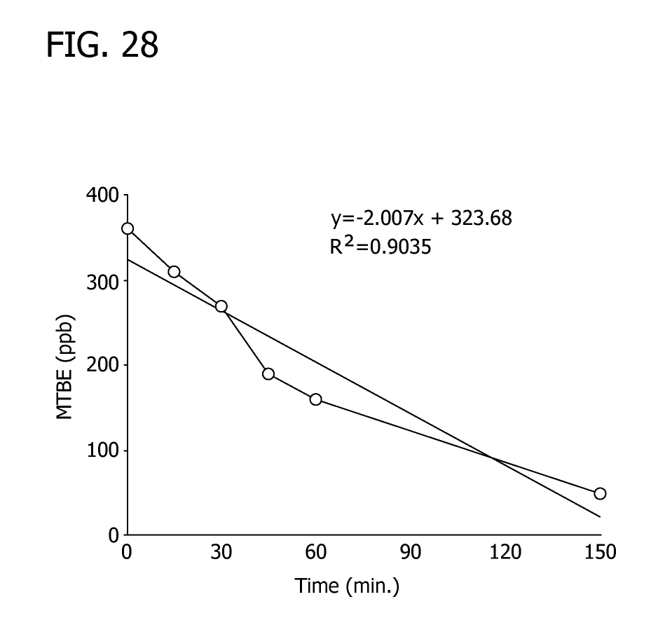

As shown in FIG. 28, MTBE was removed over time. THF was also removed over time. Table 5 summarizes the results for MTBE, THF, acetone, toluene, EB, oxylene, and 1,3,5-TMB.

TABLE 5

| | | | | | Ethyl- | | 1,3,5- |
|---|---|---|---|---|---|---|---|
| Time | MTBE | THF | Acetone | Toluene | benzene | Oxylene | TMB |
| (min) | (ppb) | (ppb) | (ppb) | (ppb) | (ppb) | (ppb) | (ppb) |
| 0 | 360 | 20 | 0 | 0 | 0 | 0 | 0 |
| 15 | 310 | 18 | 0 | 0 | 0 | 0 | 0 |
| 30 | 270 | 15 | 4 | 0 | 0 | 0 | 0 |
| 45 | 190 | 13 | 8 | 0 | 0 | 0 | 0 |
| 60 | 160 | 11 | 10 | 0 | 0 | 1 | 0 |
| 150 | 50 | 7 | 40 | 2 | 1 | 8 | 2 |

### Example 8

In this Example, the removal of gasoline constituents over time using the methods described in Example 7 was analyzed.

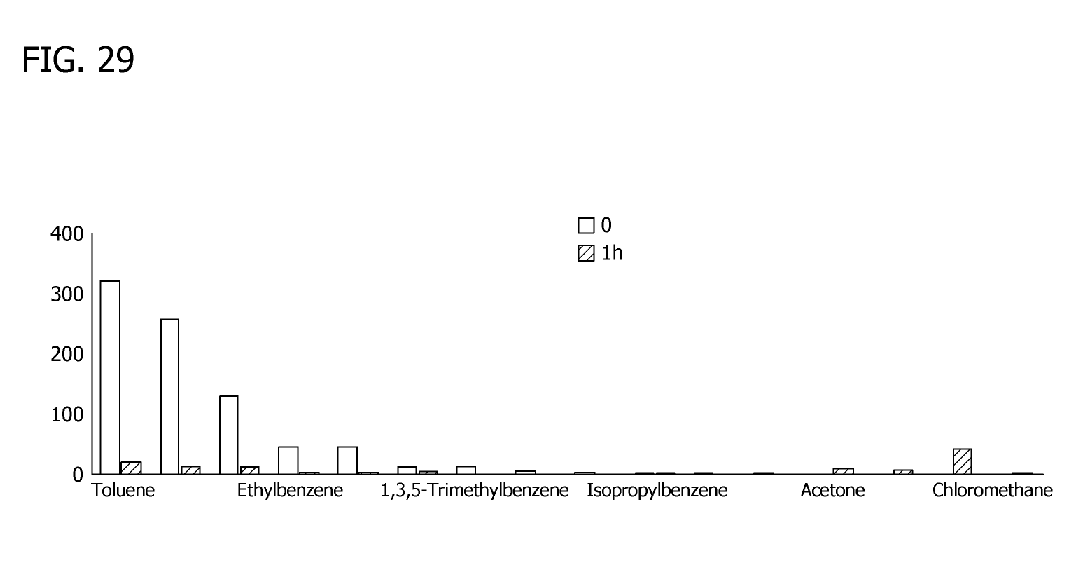

FIG. 29 shows the removal of toluene, ethylbenzene, 1,3,5-trimethylbenzene, and isopropylbenzene at time points of 0 and 1 hour. Table 6 summarizes the results for toluene, xylenes, benzene, ethylbenzene, 1,2,4-trimethylbenzene, napthlyene, 1,3,5-trimethylbenzene, N-propylbenzene, N-butylbenzene, isopropylbenzene, 1,2-dichloroethane, Sec-butylbenzene, acetone, bromodichloromethane, chloroform, and chloromethane.

TABLE 6

| Chemical | Time 0 | Time 1 h |
|---|---|---|
| Toluene | 320 | 20 |
| Xylenes | 257 | 11.7 |
| Benzene | 130 | 11 |
| Ethylbenzene | 45 | 2.3 |
| 1,2,4-trimethylbenzene | 44 | 2.5 |
| Napthlyene | 13 | 3.8 |
| 1,3,5-trimethylbenzene | 13 | 1.4 |
| N-propylbenzene | 5.2 | 0 |
| N-butylbenzene | 3.5 | 0 |
| Isopropylbenzene | 3.1 | 2 |
| 1,2-dichloroethane | 2.1 | 0 |
| Sec-butylbenzene | 1.7 | 0 |
| Acetone | 0 | 8.5 |
| Bromodichloromethane | 0 | 7.6 |
| Chloroform | 0 | 42 |
| Chloromethane | 0 | 1.5 |

### Example 9

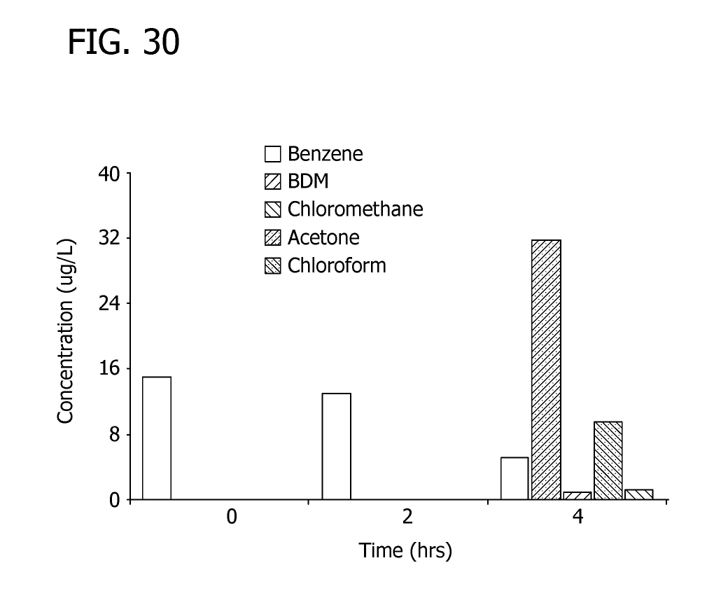

In this Example, the removal of benzene over time using the methods described in Example 7 was analyzed. Benzene concentration was reduced as shown in FIG. 30. Table 7 summarizes the results for benzene, acetone, BDM, chloroform, and chloromethane.

TABLE 7

| | Benzene | Acetone | BDM | Chloroform | Chloromethane |
|---|---|---|---|---|---|
| Time (hr) | (μg/L) | (μg/L) | (μg/L) | (μg/L) | (μg/L) |
| 0 | 15 | | | | |
| 2 | 13 | | | | |
| 4 | 5.2 | 32 | 11 | 9.7 | 1.4 |

### Example 10

In this Example, the removal of sodium phenoxyacetic acid (phenoxyacetic acid) using the methods described herein was analyzed over time. A sample was prepared using 100 μg/L initial sodium phenoxyacetic acid, 20 ppt NaCl, and Milli-Q water (4 L total volume). Samples were collected at regular intervals in 40 ml vials containing 100 μl H₂SO₄, and 100 μl sodium thiosulfate (300 mg/L). Samples were treated using the 9-watt PECO device of Example 4. Control samples were treated by (1) UV light and no applied potential (data shown); (2) no UV light and no applied potential; and (3) no UV light with applied potential. The DPD (N,N-diethyl-p-phenylenediamine) method was used for measuring chlorine.

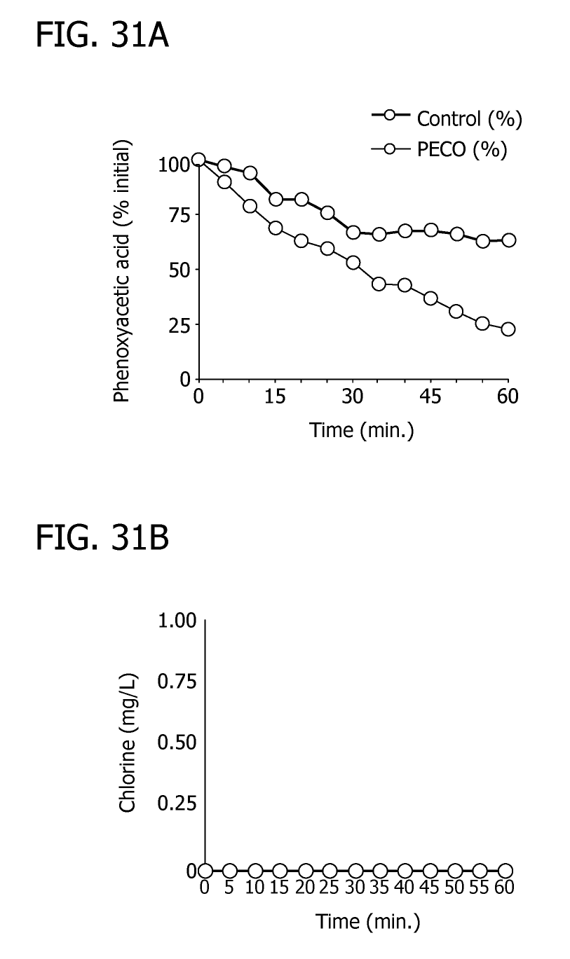

FIG. 31A shows the reduction of phenoxyacetic acid over time and FIG. 31B shows the concentration of chlorine. Table 8 summarizes the results.

TABLE 8

| Time | Current | Chlorine | | | Control | PECO |
|---|---|---|---|---|---|---|
| (min.) | (MA) | (mg/L) | Control | PECO | (%) | (%) |
| 0 | 0 | 0.0 | 805.0 | 558.0 | 100.0 | 100.0 |
| 5 | 0 | 0.0 | 780.0 | 501.0 | 96.9 | 89.8 |
| 10 | 0 | 0.0 | 756.0 | 441.0 | 93.9 | 79.0 |
| 15 | 0.0 | 0.0 | 661.0 | 388.0 | 82.1 | 69.2 |
| 20 | 0 | 0.0 | 661.0 | 353.0 | 82.1 | 63.3 |
| 25 | 0 | 0.0 | 613.0 | 335.0 | 76.1 | 60.0 |
| 30 | 0 | 0.0 | 542.0 | 299.0 | 67.3 | 53.6 |
| 35 | 0 | 0.0 | 535.0 | 245.0 | 66.5 | 43.9 |
| 40 | 0 | 0.0 | 549.0 | 243.0 | 68.2 | 43.5 |
| 45 | 0 | 0.0 | 552.0 | 210.0 | 68.6 | 37.6 |
| 50 | 0 | 0.0 | 538.0 | 177.0 | 68.8 | 31.7 |
| 55 | 0 | 0.0 | 513.0 | 147.0 | 63.7 | 26.3 |
| 0 | 0 | 0.0 | 517.0 | 133.0 | 64.2 | 23.8 |

### Example 11

In this Example, the removal of phenol using the methods described herein was analyzed over time. A sample was prepared using 10 μg/L initial phenol, 20 ppt NaCl, and Milli-Q water (4 L total volume). Samples were treated using the 9-watt PECO device of Example 4. Control samples were treated by (1) UV light and no applied potential (data shown); (2) no UV light and no applied potential; and (3) no UV light with applied potential.

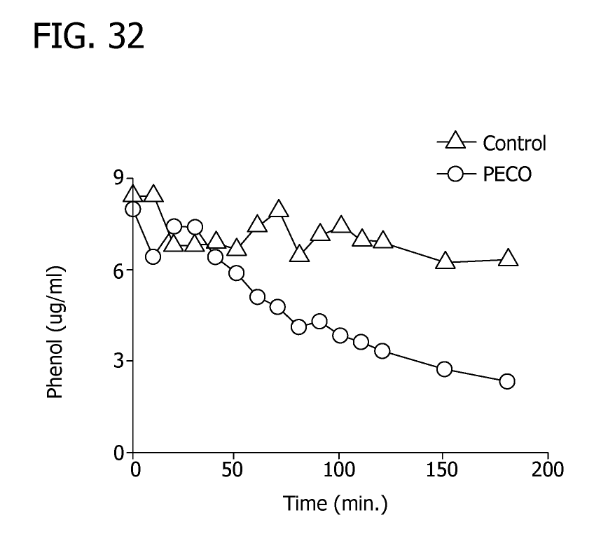

FIG. 32 shows the removal of phenol over time. Table 9 summarizes the results.

TABLE 9

| Time (min.) | Control (μg/ml) | Phenol (μg/ml) |
|---|---|---|
| 0 | 8.42 | 7.97 |
| 10 | 8.42 | 6.4 |
| 20 | 6.81 | 7.4 |
| 30 | 6.82 | 7.4 |
| 40 | 6.92 | 6.4 |
| 50 | 6.71 | 5.9 |
| 60 | 7.49 | 5.2 |
| 70 | 7.99 | 4.8 |
| 80 | 6.55 | 4.2 |
| 90 | 7.23 | 4.4 |
| 100 | 7.50 | 3.9 |
| 110 | 7.08 | 3.7 |
| 120 | 7.02 | 3.4 |
| 150 | 6.39 | 2.9 |
| 180 | 6.5 | 2.5 |

### Example 12

In this Example, the removal of carbamazepine using the methods described herein was analyzed over time. A sample was prepared using 100 ng/L (100 ppb) initial carbamazepine, 20 ppt NaCl, and Milli-Q water (4 L total volume). Samples were treated using the 9-watt PECO device of Example 4. Control samples were treated by (1) UV light and no applied potential (data shown); (2) no UV light and no applied potential; and (3) no UV light with applied potential.

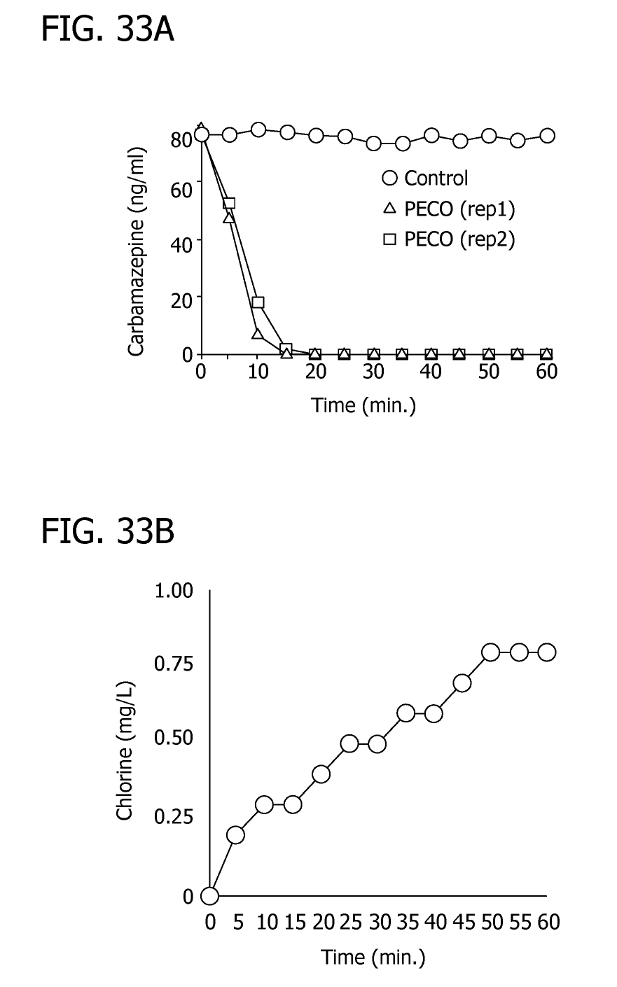

FIG. 33A shows the removal of carbamazepine over time and FIG. 33B shows the concentration of chlorine. Table 10 summarizes the results.

TABLE 10

| Time | Current | Chlorine | Carbamazepine | PECO | PECO |
|---|---|---|---|---|---|
| (min.) | (mA) | (mg/L) | Control | (rep. 1) | (rep. 2) |
| 0 | 26 | 0.0 | 76.5 | 78.2 | 76.9 |
| 5 | 29 | 0.2 | 76.5 | 47.1 | 52.6 |
| 10 | 20 | 0.3 | 78.3 | 6.9 | 18.3 |
| 15 | 20 | 0.3 | 77.4 | 0.0 | 1.4 |
| 20 | 21 | 0.4 | 76.3 | 0.0 | 0.0 |
| 25 | 21 | 0.5 | 75.9 | 0.0 | 0.0 |
| 30 | 21 | 0.5 | 73.5 | 0.0 | 0.0 |
| 35 | 21 | 0.6 | 73.5 | 0.0 | 0.1 |
| 40 | 21 | 0.6 | 76.4 | 0.0 | 0.0 |
| 45 | 22 | 0.7 | 74.4 | 0.0 | 0.0 |
| 50 | 22 | 0.8 | 76.3 | 0.0 | 0.0 |
| 55 | 22 | 0.8 | 74.7 | 0.0 | 0.0 |
| 60 | 22 | 0.8 | 76.5 | 0.0 | 0.0 |

### Example 13

In this Example, the removal of triclosan using the methods described herein was analyzed over time. A sample was prepared using 20 μg/L initial triclosan, 20 ppt NaCl, and Milli-Q water (4 L total volume). Samples were treated using the 9-watt PECO device of Example 4. Control samples were treated by (1) UV light and no applied potential (data shown); (2) no UV light and no applied potential; and (3) no UV light with applied potential.

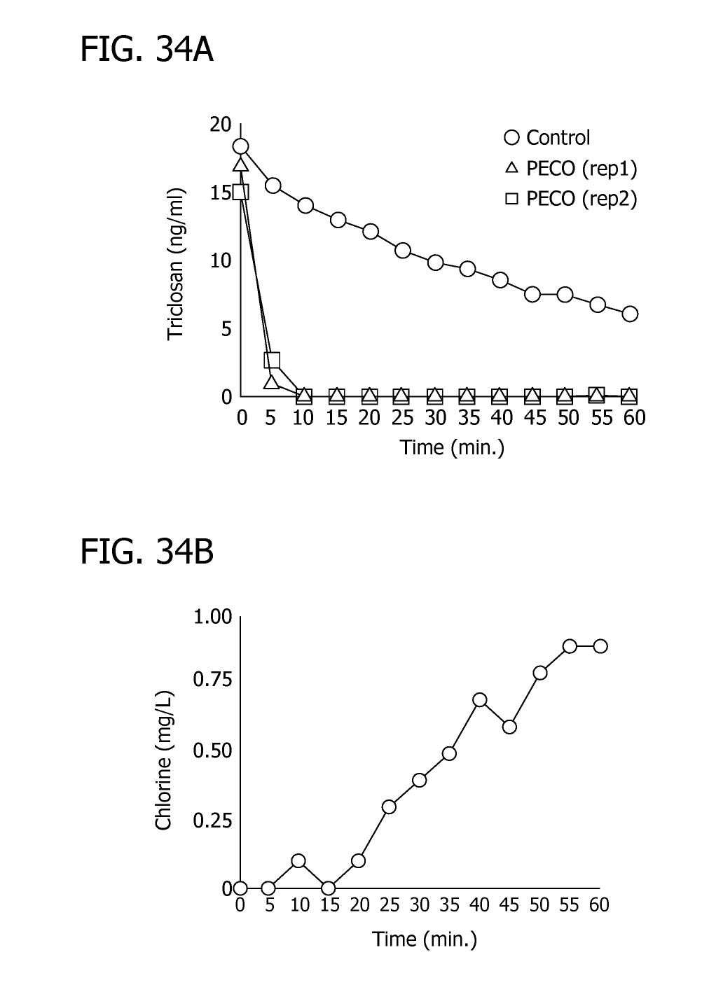

FIG. 34A shows the removal of triclosan over time and FIG. 34B shows the concentration of chlorine. Table 11 summarizes results.

TABLE 11

| | | | Triclosan | | |
|---|---|---|---|---|---|
| Time | Current | Chlorine | Control | PECO | PECO |
| (min.) | (mA) | (mg/L) | (ng/ml) | (rep. 1) | (rep. 2) |
| 0 | 23 | 0.0 | 18.4 | 16.9 | 15.0 |
| 5 | 22 | 0.0 | 15.5 | 1.0 | 2.7 |
| 10 | 22 | 0.1 | 14.1 | 0.0 | 0.1 |
| 15 | 22 | 0.0 | 13.0 | 0.0 | 0.0 |
| 20 | 22 | 0.1 | 12.2 | 0.1 | 0.1 |
| 25 | 22 | 0.3 | 10.8 | 0.0 | 0.0 |
| 30 | 22 | 0.4 | 9.9 | 0.0 | 0.0 |
| 35 | 22 | 0.5 | 9.5 | 0.0 | 0.0 |
| 40 | 22 | 0.7 | 8.7 | 0.0 | 0.0 |
| 45 | 22 | 0.6 | 7.6 | 0.0 | 0.0 |
| 50 | 22 | 0.8 | 7.6 | 0.0 | 0.0 |
| 55 | 23 | 0.9 | 6.9 | 0.0 | 0.1 |
| 60 | 23 | 0.9 | 6.2 | 0.1 | 0.0 |

### Example 14

In this Example, methyl tertiary-butyl ether is removed from synthetically prepared MTBE-spiked water samples and MTBE contaminated groundwater. For synthetically prepared MTBE-spiked water samples, reagent-grade MTBE (97%, Sigma Aldrich Chemical Co., Milwaukee, Wis.) is used to prepare a stock solution of 1000 mg/L MTBE in deionized water. The reaction solutions are prepared by diluting the 1000 mg/L MTBE stock solution to the desired MTBE concentration with deionized oxygenated water. The water is oxygenated to permit the measurement of total organic carbon (TOC) with minimal interference from dissolved CO₂ in the samples. Water contaminated with MTBE is kept in airtight Pyrex flasks with no headspace at the onset of the reaction to avoid MTBE volatilization.

Effect of Salt Concentration on MTBE removal

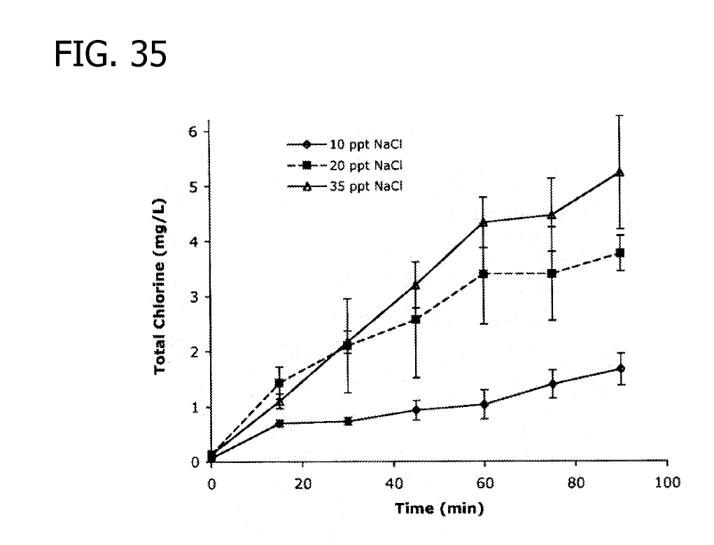

The effect of NaCl concentration on the degradation of MTBE at an initial concentration of 500 μg/L is evaluated. The following NaCl concentrations are tested: 1, 2, 5, 10 and 20 g/L. These NaCl concentrations are tested because of their differing effects on chlorine generation by a 9-watt PECO device as shown in FIG. 35. MTBE and its expected by-products are measured by GC-MS for each NaCl concentration. Chlorine production is also measured.

### Effect of Initial MTBE Concentration

The effect of initial MTBE concentration on degradation efficiency and order of reaction is performed. Initial MTBE concentrations of 1 μg/L, 10 μg/L, 100 μg/L, 1 mg/L, and 10 mg/L are used. Photoelectrocatalytic oxidation is performed until complete mineralization is achieved as measured by TOC. MTBE and its by-products are determined by GC-MS. Rate constants are estimated by assuming that the system follows pseudo-first-order kinetics (i.e., from the slopes of the lines produced by plotting −ln (C/C₀) versus time). Other kinetic rate models, including zero- and second-order power-law kinetics models, as well as Langmuir-Hinshelwood expressions, are analyzed to determine if these models provide better fits to the data.

### Effect of Competing Organic Compounds on MTBE Removal

MTBE-contaminated groundwater samples are evaluated to determine the impact of competing contaminates in the water on MTBE removal kinetics. The groundwater samples are analyzed in triplicate photoelectrocatalytic oxidation units until there is complete mineralization of all compounds in the water. The levels of MTBE, its by-products, and BTEX compounds are measured at each time point.

What is claimed is:

1. A method of treating an aqueous solution to reduce amounts of a contaminant, the method comprising:
providing in a closed system an aqueous solution comprising at least one contaminant selected from the group consisting of an organism, an organic chemical, a non-nitrogen inorganic chemical, and combinations thereof;
providing a housing member having an inlet and an outlet, the housing member adapted to house a photoanode and a cathode, the housing member further comprising a transparent member adapted to permit light from a light source to irradiate the photoanode; and
exposing the aqueous solution to photoelectrocatalytic oxidization, wherein one or more contaminant is oxidized by a free radical produced by the photoanode, wherein the photoanode comprises a solid nanoporous film member having a median pore diameter in the range of 0.1 nm to 500 nm constructed from titanium dioxide nanoparticles.

2. The method of claim 1, wherein the aqueous solution comprises groundwater, wastewater, drinking water, aquarium water, ballast water, and aquaculture water.

3. The method of claim 1, wherein the aqueous solution is groundwater.

4. The method of claim 1, wherein the aqueous solution is wastewater.

5. The method of claim 1, wherein the aqueous solution is drinking water.

6. The method of claim 1, wherein the aqueous solution is aquarium water.

7. The method of claim 1, wherein the aqueous solution is ballast water.

8. The method of claim 1, wherein the aqueous solution is aquaculture water.

9. The method of claim 1, wherein the free radical is at least one of a hydroxyl radical and a chlorine atom.

10. The method of claim 1, wherein the one or more contaminant is oxidized on, or proximate to, a surface of the photoanode.

11. The method of claim 1, wherein the organism is a microorganism.

12. The method of claim 11, wherein the microorganism comprises at least one of a prokaryote, a eukaryote, and a virus.

13. The method of claim 12, wherein the prokaryote comprises Escherichia.

14. The method of claim 1, wherein the organic chemical comprises at least one of acetone, acid blue 9, acid yellow 23, acrylamide, alachlor, atrazine, benzene, benzo(a)pyrene, bromodichloromethane, carbofuran, carbon tetrachloride, chlorobenzene, chlorodane, chloroform, chloromethane, 2,4-dichlorophenoxyacetic acid, dalapon, 1,2-dibromo-3-chloropropane, o-dichlorobenzene, p-dichlorobenzene, 1,2-dichloroethane, 1,1-dichloroethylene, cis-1,2-dichloroethylene, trans-1,2-dichloroethylene, dichlormethane, 1,2-dichloropropane, di(2-ethylhexyl) adipate, di(2-ethylhexyl) phthalate, dinoseb, dioxin (2,3,7,8-TCDD), diquat, endothall, endrin, epichlorohydrin, ethylbenzene, ethylene dibromide, glyphosate, a haloacetic acid, heptachlor, heptachlor epoxide, hexachlorobenzene, hexachlorocyclopentadiene, lindane, methyl-tertiary-butyl ether, methyoxychlor, napthoxamyl (vydate), naphthalene, pentachlorophenol, phenol, picloram, isopropylbenzene, N-butylbenzene, N-propylbenzene, Sec-butylbenzene, polychlorinated biphenyls (PCBs), simazine, sodium phenoxyacetic acid, styrene, tetrachloroethylene, toluene, toxaphene, 2,4,5-TP (silvex), 1,2,4-trichlorobenzene, 1,1,1-trichloroethane, 1,1,2-trichloroethane, trichloroethylene, a trihalomethane, 1,2,4-trimethylbenzene, 1,3,5-trimethylbenzene, vinyl chloride, o-xylene, m-xylene, p-xylene, an endocrine disruptor, protein, a G-series nerve agent, a V-series nerve agent, bisphenol-A, bovine serum albumin, carbamazepine, cortisol, estradiol-17β, gasoline, gelbstoff, triclosan, ricin, a polybrominated diphenyl ether, a polychlorinated diphenyl ether, and a polychlorinated biphenyl.

15. The method of claim 1, wherein the non-nitrogen inorganic chemical comprises at least one of aluminum, antimony, arsenic, asbestos, barium, beryllium, bromate, cadmium, chloramine, chlorine, chlorine dioxide, chlorite, chromium, copper, cyanide, fluoride, iron, lead, manganese, mercury, nickel, nitrate, nitrite, selenium, silver, sodium, sulfate, thallium, and zinc.

16. The method of claim 1, wherein the contaminant is methyl tertiary-butyl ether.

17. A method of environmental remediation, the method comprising:
providing in a closed system a sample of environmental medium comprising at least one contaminant selected from the group consisting of an organism, an organic chemical, a non-nitrogen inorganic chemical, and combinations thereof;
providing a housing member having an inlet and an outlet, the housing member adapted to house a photoanode and a cathode, the housing member further comprising a transparent member adapted to permit light from a light source assembly disposed exterior to the housing member to irradiate the photoanode; and
exposing the sample of environmental medium to photoelectrocatalytic oxidization, wherein one or more contaminant is oxidized by a free radical produced by the photoanode, wherein the photoanode comprises a solid, uncoated nanoporous film member having a median pore diameter in the range of 0.1 nm to 500 nm constructed from titanium dioxide nanoparticles.

18. The method of claim 17, wherein the environmental medium comprises at least one of groundwater and surface water.

19. The method of claim 17, wherein the one or more contaminant is oxidized on, or proximate to, a surface of the photoanode.

20. A method of treating an aqueous solution to reduce amounts of a contaminant, the method comprising:
providing in a closed system an aqueous solution comprising at least one contaminant selected from the group consisting of an organism, an organic chemical, a non-nitrogen inorganic chemical, and combinations thereof;
providing a housing member having an inlet and an outlet, the housing member adapted to house a photoanode, a cathode, and a light source assembly configured to irradiate the photoanode; and
exposing the aqueous solution to photoelectrocatalytic oxidization, wherein one or more contaminant is oxidized by a chlorine atom produced by the photoanode, wherein the photoanode comprises a solid, uncoated nanoporous film member having a median pore diameter in the range of 0.1 nm to 500 nm constructed from titanium dioxide nanoparticles.
